(19) United States
(12) Patent Application Publication
(10) Pub. No.: US 2024/0071707 A1
(43) Pub. Date: Feb. 29, 2024

(54) Systems and Methods for Protective X-Ray Enclosure Access

(71) Applicant: Varex Imaging Corporation, Salt Lake City, UT (US)

(72) Inventors: Dave Kirkham, South Jordan, UT (US); Vance Scott Robinson, South Jordan, UT (US); Colton B. Woodman, Magna, UT (US); Jake Riggle, Bountiful, UT (US)

(73) Assignee: Varex Imaging Corporation, Salt Lake City, UT (US)

(21) Appl. No.: 18/248,516

(22) PCT Filed: Jul. 20, 2022
(86) PCT No.: PCT/US2022/037771

§ 371 Date: Nov. 2, 2023

Related U.S. Application Data
(60) Provisional application No. 63/223,896, filed on Jul. 20, 2021.

(51) Int. Cl. H01J 35/16

(52) U.S. Cl. CPC H01J 35/16

(57) ABSTRACT

Some embodiments include an x-ray device comprising: an access port configured to receive a cathode within an interior volume of an enclosure of the x-ray device; a first vacuum seal configured to seal a cover over the access port; and a second seal configured to seal the cover over the access port, the second seal maintained between the first vacuum seal and the interior volume of the enclosure during removal of the first vacuum seal.

Unless otherwise indicated herein, the approaches described in this section are not prior art to the claims in this disclosure and are not admitted to be prior art by inclusion in this section.

Components of an x-ray source may be vacuum sealed within an enclosure. For example, the vacuum chamber of an x-ray tube may be permanently welded during manufacture. Although vacuum sealing may enable the x-ray tube to withstand and dissipate heat produced during operation, the welded seal can thwart post-fabrication testing, validation, and repair; breaching the vacuum sealed enclosure of an x-ray tube may be difficult, time consuming, and introduce contaminants, rendering the tube unsalvageable.

### BRIEF DESCRIPTION OF SEVERAL VIEWS OF THE DRAWINGS

FIGS. 1-3 illustrate examples of x-ray devices with an overlapping cover of an access port according to some embodiments.

FIGS. 4A-4B illustrate examples of x-ray devices with an overlapping cover of a recessed access port according to some embodiments.

FIGS. 5A-5B illustrate examples of x-ray devices with an overlapping lipped cover of an access port according to some embodiments.

FIGS. 6A-6B illustrate examples of x-ray devices with an overlapping lipped cover of a recessed access port according to some embodiments.

FIGS. 7A-8B illustrate examples of x-ray devices with an overlapping cover of an access port with a secondary seal according to some embodiments.

FIGS. 9A-10B illustrate examples of x-ray devices with an overlapping channeled cover of an access port with a protrusion according to some embodiments.

FIGS. 11A-12B illustrate examples of protective resealable vacuum sealing systems for x-ray device enclosures with access ports.

FIGS. 13A-16C illustrate examples of temporary protective vacuum sealing systems for x-ray device enclosures with access ports.

FIGS. 17A-17B illustrate examples of protective vacuum sealing systems for multi-emitter x-ray devices within an enclosure.

FIG. 18 illustrates examples of protective vacuum sealing systems for multi-emitter x-ray devices within an enclosure with multiple access ports.

FIGS. 19A-19B illustrate examples of cathode modules with multiple fasteners according to some embodiments.

FIGS. 20A-22B illustrate examples of cathode modules with at least one compression plate according to some embodiments.

FIG. 23 illustrates an example of an x-ray device including an anode assembly according to some embodiments.

FIGS. 24A-24B illustrate examples of an x-ray device with segmented anode assemblies according to some embodiments.

FIGS. 25A-26C illustrate examples of segmented anode assemblies according to some embodiments.

FIGS. 27 and 28 are flow diagrams of examples of methods for sealing a vacuum enclosure of an x-ray device.

FIG. 29 is a flow diagram of an example method for manufacturing cathode of an x-ray device according to some embodiments.

FIG. 30 is a flow diagram of an example method for manufacturing anode of an x-ray device according to some embodiments.

FIG. 31 is a flow diagram of an example of a method for manufacturing a cathode and sealing a vacuum enclosure of an x-ray device according to some embodiments.

### DETAILED DESCRIPTION

Components of an x-ray source, such as cathodes and anodes, may be permanently vacuum sealed within an enclosure, e.g., by welding, brazing, permanent bonding, or the like. However, conventional approaches to vacuum sealing may be adequate for single cathode (with one to three emitters) and a single anode assembly, but can complicate manufacturing and thwart post-fabrication testing, validation, and repair for x-ray sources with multiple cathode modules where a single failure mechanism can make the x-ray source unusable. Once the enclosure of an x-ray device is vacuum sealed, access to the interior volume may no longer be feasible, which may prevent components that fail during initial validation testing, or subsequent use, from being replaced or repaired. For example, opening many types of permanent vacuum seals may involve debonding, milling, cutting, and/or other debris-producing processes. The debris produced while opening these types of vacuum seals may contaminate the enclosure (which can create arcing), damage internal components, disrupt electrical connections, and similar issues. Repairing this damage may not be practical or possible. These issues may be exacerbated in implementations comprising multiple x-ray emitters or cathode modules within a vacuum enclosure. A multi-emitter x-ray source may include many cathode modules (e.g., 6 or more, such as 96). Therefore, a failure of a single component within the vacuum sealed enclosure of an x-ray device may render the entire x-ray device inoperable and/or unsuitable for repair.

Some embodiments relate to protective vacuum sealing systems for x-ray device enclosures, such as x-ray sources, x-ray tubes, x-ray tube bodies, and the like. The body of the enclosure may include access port configured to provide access to components within the interior of the enclosure. For example, the access port may enable a cathode to be inserted into the enclosure, removed from the enclosure, and so on. The protective vacuum sealing system may be configured to vacuum seal the access port. The protective vacuum sealing system may be further configured to protect the interior from damage during removal of the vacuum seal. As disclosed in further detail herein, the protective vacuum sealing system may include a primary sealing mechanism configured to form a primary, vacuum-capable seal over the access port and a secondary sealing mechanism configured to maintain a secondary seal or barrier over the access port during removal of the primary vacuum seal. The secondary seal may, for example, be configured to prevent contamination of the enclosure by debris produced as the primary vacuum seal is breached.

In some embodiments, the protective vacuum sealing system may enable components of an x-ray device to be evaluated, inspected, repaired, and/or replaced after the enclosure of the x-ray device has been vacuum sealed. The protective vacuum sealing system may be used to salvage x-ray devices that fail initial validation testing and/or fail while in service. In response to a validation failure, such as an under-performing emitter, the protective vacuum sealing system can be used to safely unseal the access port, enabling the failed component(s) to be repaired and/or replaced. The protective vacuum sealing system may then be used to reseal the access port, enabling the x-ray device to reenter service rather than being scrapped.

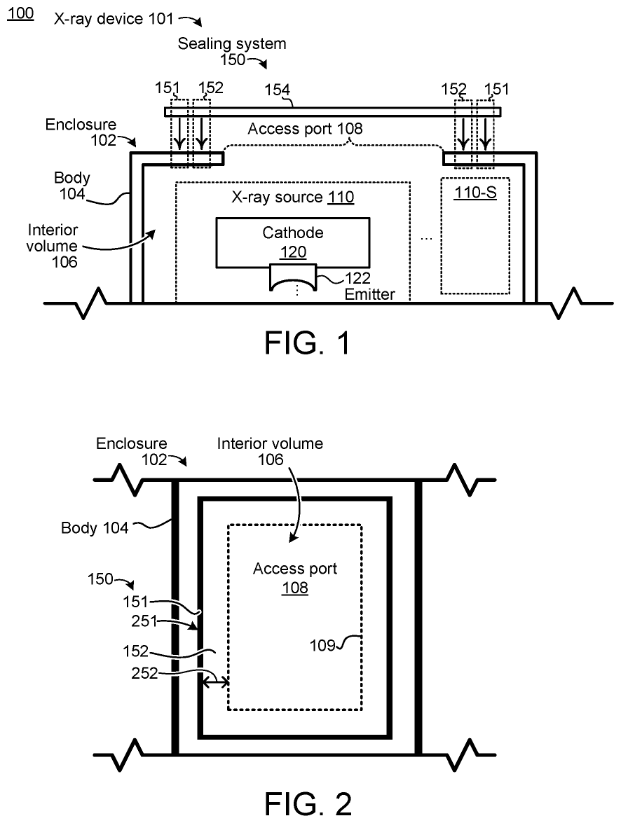

FIGS. 1-3 illustrate examples of x-ray devices with an overlapping cover of an access port according to some embodiments. FIG. 1 illustrates an example of a system 100 including an x-ray device 101 according to some embodiments. The system 100 may comprise an imaging system, an irradiation system, or the like. FIG. 1 is a side cut-away view illustrating one example of an enclosure 102 of the x-ray device 101. FIG. 2 is a top-down view of the enclosure 102 shown in FIG. 1 Referring to FIGS. 1 and 2, the enclosure 102 may be part of an x-ray source, an x-ray tube, an x-ray tube body, a vacuum tube, a vacuum chamber, and/or the like. The enclosure 102 may include a body 104 defining, at least in part, an interior volume 106 of the enclosure 102.

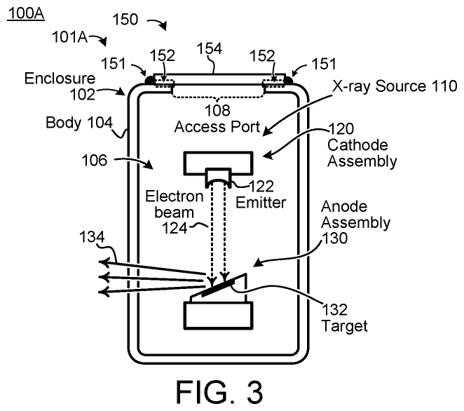

The enclosure 102 may comprise components of an x-ray source 110 or multiple x-ray sources 110 (illustrated as x-ray source 110 to 110-S), each x-ray source 110 comprising a respective cathode 120 having an emitter 122 and an anode 130 (as illustrated in FIG. 3). The emitter 122 may comprise any suitable electron emission means including, but not limited to a thermionic emitter, a filament emitter, a field emitter, an electron gun, or the like. The field emitter may include a variety of types of emitters. For example, the field emitter may include a nanotube emitter, a nanowire emitter, a Spindt array, or the like. Conventionally, nanotubes have at least a portion of the structure that has a hollow center, where nanowires or nanorods has a substantially solid core. For simplicity in use of terminology, as used herein, nanotube also refers to nanowire and nanorod. A nanotube refers to a nanometer-scale (nm-scale) tube-like structure with an aspect ratio of at least 100:1 (length:width or diameter). A Spindt array may include individual field emitters with small sharp cones using an electron generating material, such as molybdenum (Mo) or Tungsten (W). In some embodiments, the field emitter is formed of an electrically conductive or semi-conductive material with a high tensile strength and high thermal conductivity such as carbon, metal oxides (e.g., Al₂O₃, titanium oxide (TiO₂), zinc oxide (ZnO), or manganese oxide (MnₓO_{y}, where x and y are integers)), metals, sulfides, nitrides, and carbides, either in pure or in doped form, or the like. Although a cathode 120 may include a single emitter 122, in other embodiments, a cathode 120 may include multiple emitters 122. A cathode 120 is configured to generate a focal spot of an electron beam on a corresponding anode 130. The x-ray source 110 may comprise and/or be operably coupled to a corresponding anode 130, as disclosed in further detail herein (not shown in FIG. 1 to avoid obscuring details of the illustrated examples). Although an x-ray source 110 with a single cathode 120 and emitter 122 is used as an example, in other embodiments, a cathode 120 may include multiple cathodes 120, multiple emitters 122, or the like.

An access port 108 may be formed in the body 104. The access port 108 may comprise any suitable means for providing access to the interior volume 106 of the enclosure 102, including, but not limited to: an opening, a hole, a void, and/or the like in the enclosure 102. The access port 108 may be configured to allow the cathode and/or other components of the x-ray source 110 to be visually inspected, inserted into the enclosure 102, removed from the enclosure 102, physically manipulated, and/or otherwise accessed.

As described above, some approaches to vacuum sealing can complicate manufacturing and thwart post-fabrication testing, validation, and repair. These and other issues may be addressed by embodiments of the technology for protective sealed-enclosure access disclosed herein. In the examples illustrated in FIGS. 1 and 2, a sealing system 150 is configured to vacuum seal the enclosure 102 of the x-ray device 101. The sealing system 150 may provide for safe removal of the vacuum seal, without contaminating or otherwise damaging the x-ray source 110 (or other components within the enclosure 102). As such, the sealing system 150 may enable internal components of the x-ray device 101, such as the cathode, to be repaired and/or replaced without damaging the enclosure 102.

The sealing system 150 comprises a primary seal 151 configured to form a vacuum seal on the enclosure 102 over the access port 108. As used herein, a vacuum seal refers to a seal configured to maintain a low-pressure, near vacuum, or vacuum pressure differential between the interior volume 106 of the enclosure 102 and the external environment.

The primary seal 151 may be configured to vacuum seal the cover 154 to the access port 108. The cover 154 may comprise any suitable means for vacuum sealing the access port 108 including, but not limited to a plate, a lid, a cover, a window, a porthole, gasket, and/or the like. The cover 154 may be seal the access port 108 by compressing a gasket. The cover 154 may be formed of vacuum-compatible materials, e.g., materials capable of maintaining a low pressure or vacuum state within the interior volume 106, such as airtight materials, non-porous materials, metal, bronze, brass, steel, iron, aluminum, lead, plastic, rubber, silicone, and/or the like.

The primary seal 151 of the sealing system 150 may be configured for forming a permanent or long-term vacuum seal between the cover 154 and the body 104. As used herein, a permanent or long-term seal refers to a seal that is configured to persist during the usable life of the x-ray source 110. A permanent or long-term seal may be formed by one or more of: fusion, welding, fusion welding, solid-state welding, brazing, soldering, bonding, chemical bonding, permanent adhesion, and/or the like.

The sealing system 150 further comprises a secondary seal 152 configured to protect the interior volume 106 from contamination or damage during removal of the primary seal 151. As disclosed in further detail herein, the secondary seal 152 may be configured to form and/or maintain a protective barrier between the primary seal 151 and the interior volume 106 of the enclosure 102. The secondary seal 152 may be disposed between the primary seal 151 and the interior volume 106 of the enclosure 102.

The secondary seal 152 may be configured to protect the interior volume 106 of the enclosure 102 from contamination and/or other damage during removal of the primary seal 151. The secondary seal 152 may or may not be a vacuum seal. The secondary seal 152 may be configured to be removed or released without contamination and/or damage to the x-ray source 110 or other internal components. The secondary seal 152 may comprise one or more mechanical seals, which may include, but are not limited to a pressure seal, a hydrostatic seal, a contact seal, a compression seal, a clamp, a bolt, a friction seal, physical engagement, a physical engagement seal, a surface engagement seal, a gasket, a rubber gasket, a silicon gasket, an adhesive gasket, a sheet gasket, a solid-material gasket, a braze material gasket, a spiral-wound gasket, a double-jacketed gasket, a Kammprofile gasket, a Fishbone gasket, a ring-type gasket, an O-ring, an adhesive seal, a releasable adhesive seal, an adhesive material, a releasable adhesive material, a sealant, a sealant material, a removable sealant, and/or the like.

The sealing system 150 can be used to vacuum seal the enclosure 102 such that the enclosure 102 can be subsequently accessed without contamination of the interior volume 106. The secondary seal 152 may be disposed within the primary seal 151 relative to the access port 108. As a result, the secondary seal 152 is configured to a) protect the interior volume 106 from contamination during removal of the primary seal 151 and b) enable the cover 154 to be removed or released from the body 104 without contaminating or otherwise damaging the interior volume 106. The secondary seal 152 may be configured to form and/or maintain a protective barrier by contact between a sufficient length of two surfaces, such as a cover 154 and the body 104, the various gaskets or seals described above, or the like. This secondary seal 152 may remain completely or sufficiently sealed during removal of the primary seal 151. As a result, the contamination may be substantially stopped by the secondary seal 152. The contamination may be removed from an exterior of the enclosure 102 before the secondary seal 152 is broken.

In some embodiments, the primary seal 151 may be configured to surround the perimeter 109 of the access port 108. The primary seal 151, therefore, is capable of vacuum sealing the access port 108. The secondary seal 152 and/or corresponding secondary seal 152 may also be configured to surround the perimeter 109 of the access port 108. In some embodiments, the secondary seal 152 may be disposed within the primary seal 151 with respect to the access port 108. In other words, the primary seal 151 may be formed along a first path around a perimeter of the access port 108 and the secondary seal 152 may be formed along a second path around the perimeter of the access port 108, the second path within the first path between the first path and the access port 108. Accordingly, the secondary seal 152 and/or corresponding secondary seal 152 can prevent debris produced during removal of the primary seal 151 from contaminating the interior volume 106.

In some embodiments, the outer perimeter of the cover 154 may be configured to overlap the body 104 of the enclosure 102 when positioned over the access port 108. The primary seal 151 may comprise a weld or other permanent bond at and/or within a first overlap area 251 such as along the outer edge of the cover 154. The secondary seal 152 may comprise, at least in part, a second overlap area 252. The second overlap area 252 may be disposed between the cover 154 and the body 104 of the enclosure 102 and between the access port 108 and the primary seal 151. In some embodiments, the second overlap area 252 may be configured to have a threshold size or extent (e.g., the extent measured from the primary seal 151 to the perimeter 109 of the access port 108 at respective points along the perimeter 109 of the access port 108). The threshold size may be a size sufficient to ensure that the secondary seal 152 can adequately protect the enclosure 102 from contamination during removal of the primary seal 151. The threshold size may be determined by testing, experience, simulation, seal type, seal material, enclosure material, and/or the like. In some embodiments, the threshold size is at least 5 millimeters (mm), e.g., the extent of surface engagement and/or overlap comprising the secondary seal 152 may be at least 5 mm at each point along the perimeter 109 of the access port 108. In other implementations, the threshold width may be 10 mm or above (when used with materials and/or primary seals 151 that produce more debris, debris at higher velocities, or the like).

The sealing system 150 may facilitate validation testing and repair of the x-ray device 101. The sealing system 150 may be used to vacuum seal the enclosure 102 for initial validation testing by use of the primary seal 151. Components identified as failing validation testing may be replaced by removing the primary seal 151. During removal of the primary seal 151, the interior volume 106 of the enclosure 102 is protected from contamination by the secondary seal 152.

FIG. 3 illustrates additional examples of systems 100A and x-ray devices 101A according to some embodiments. The system 100A may be similar to the system 100 described above. The x-ray source 110 may comprise a cathode 120 and anode 130. During operation, the cathode 120 directs an electron beam 124 to a target 132 of the anode 130, which converts at least a portion of the energy into x-ray radiation 134. Although a single target 132 and a single electron beam 124 have been used as an example, in other embodiments, each anode 130 may include multiple targets 132, a single target with multiple focal spots from multiple electron beams 124, or the like.

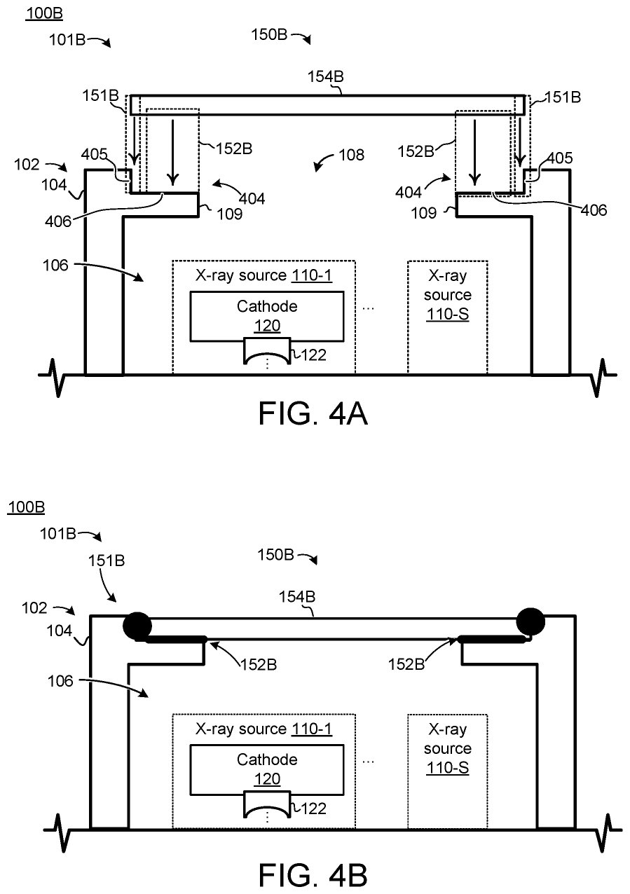

FIGS. 4A-4B illustrate examples of x-ray devices with an overlapping cover of a recessed access port according to some embodiments. Referring to FIG. 4A, a system 100B including an x-ray device 101B may be similar to systems 100 and 100A described above, including similar components. In some embodiments, the cover 154B of the sealing system 150B is configured to physically engage with the body 104. The body 104 comprises an engagement structure, such as a notch 404 or the like. The notch 404 may be formed around a perimeter 109 of the access port 108. The notch 404 may be configured to engage with the cover 154B; the dimensions and/or configuration of the notch 404 may correspond to the dimensions and/or configuration of the cover 154B such that the cover 154B can be fit within the notch 404.

The primary seal 151B may comprise a portion of the cover 154B and body 104. The primary seal 151B may comprise a vertical section 405 of the notch 404. Similarly, the secondary seal 152B may comprise another portion of the cover 154B and body 104. The secondary seal 152B may comprise a horizontal section 406 of the notch 404.

Referring to FIG. 4B, the enclosure 102 is in a closed, vacuum sealed state. In this example, the primary seal 151B comprises a weld sealing the outer edge of the cover 154B to body 104 at the vertical section 405 of the notch 404 formed in the body 104. The secondary seal 152B may be configured to maintain a secondary seal 152B between the primary seal 151B and the interior volume 106 during removal of the primary seal 151B, as disclosed herein.

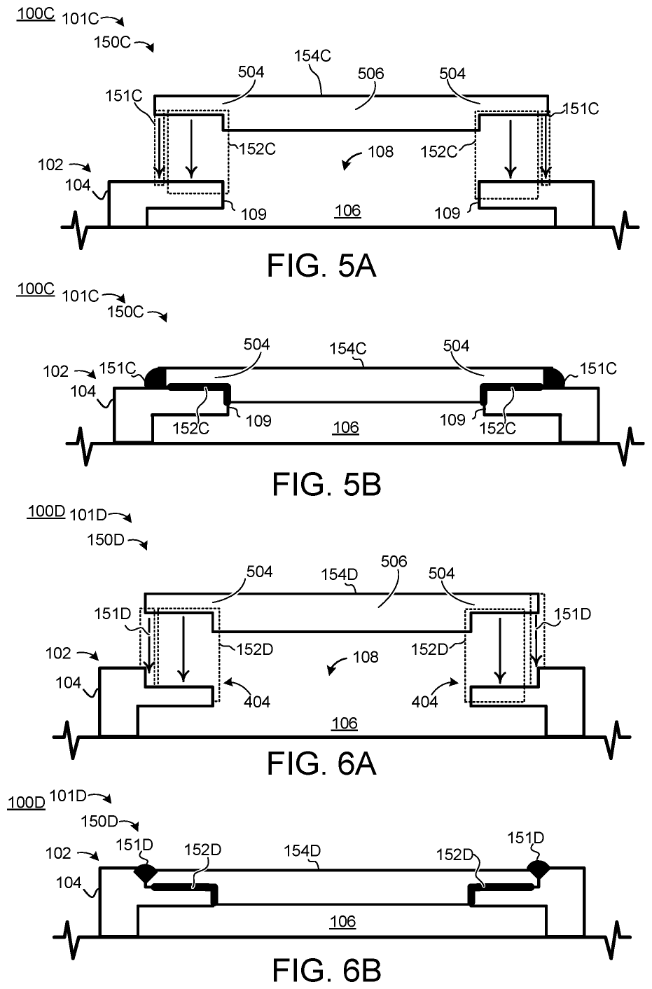

FIGS. 5A-5B illustrate examples of x-ray devices with an overlapping lipped cover of an access port according to some embodiments. Referring to FIGS. 5A-5B, a system 100C including an x-ray device 101C may be similar to systems 100 and 100A described above, including similar components. The cover 154C of the sealing system 150C may comprise a lip 504 and center section 506 configured to physically engage or partially enter the access port 108. The center section 506 of the cover 154C may be configured to fit within and/or extend into the access port 108.

The primary seal 151C includes the outside edge of the cover 154C and a portion of the body 104. The secondary seal 152C includes a portion of the lip (or flange) 504 and the center section 506 of the cover 154C and a portion of around the perimeter 109 of the access port 108.

Referring to FIG. 5B, the enclosure 102 is in a closed, vacuum sealed state. The primary seal 151C of the sealing system 150C is formed by welding the outside edge of the cover 154C to the body 104. The secondary seal 152C may comprise a mechanical seal maintained by engagement between the body 104 and the lip 504, and/or engagement between the center section 506 and the perimeter 109 of the access port 108.

FIGS. 6A-6B illustrate examples of x-ray devices with an overlapping lipped cover of a recessed access port according to some embodiments. Referring to FIGS. 6A-6B, a system 100D including x-ray device 101D may be similar to systems 100, 100A, 100B, and 100C described above, including similar components. The cover 154D is configured to physically engage with the access port 108 of the enclosure 102. The cover 154D may comprise a lip 504 and center section 506. The body 104 may also be configured for physical engagement with the cover 154D with engagement of a notch 404D and an outside edge of the cover 154D as the primary seal 151D. The secondary seal 152D may comprise engagements between the lip 504 of the cover 154D and the notch 404 formed in the body 104 and b) the center section 506 and the perimeter 109 of the access port 108.

Referring to FIG. 6B, the enclosure 102 is in a closed, vacuum sealed state. The primary seal 151D may be formed by welding the outside edge of the cover 154 to the body 104 to form the primary seal 151D). The secondary seal 152D may comprise a mechanical seal maintained by engagement between the lip 504 and the notch 404 and/or the perimeter of the access port 108 and the center section 506.

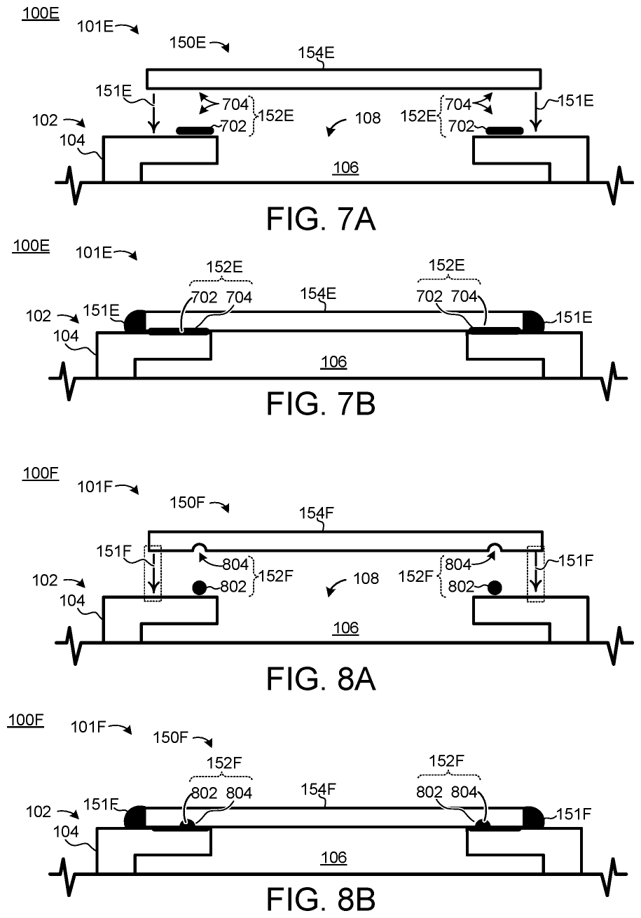

FIGS. 7A-8B illustrate examples of x-ray devices with an overlapping cover of an access port with a secondary seal according to some embodiments. Referring to FIGS. 7A-7B a system 100E including x-ray device 101E may be similar to system 100 described above, including similar components. The secondary seal 152E comprises a secondary seal member 702. The secondary seal member 702 may be configured to surround the access port 108. The secondary seal member 702 may comprise component(s) of a temporary, non-debris-producing seal, as disclosed herein, such as a mechanical seal, gasket, O-ring, or the like. The secondary seal 152E may further comprise overlapping surfaces 704 of the cover 154E and body 104, the overlapping surfaces 704 configured to engage the secondary seal member 702, e.g., contact or compress the secondary seal member 702.

Referring to FIG. 7B, the enclosure 102 is in a closed, vacuum sealed state. The enclosure 102 may be sealed by a sealing system 150E similar to the sealing system 150 described above with the primary seal 151E of the sealing system 150E formed by welding the outside edge of the cover 154E to the body 104. The secondary seal 152E may be configured to form and/or maintain a secondary seal 152E comprising a mechanical seal maintained by engagement between the overlapping surfaces 704 of the cover 154E and body 104, and engagement between the overlapping surfaces 704 and the secondary seal member 702.

Referring to FIG. 8A-8B, a system 100F including x-ray device 101F may be similar to systems 100 and 100E described above, including similar components. The secondary seal 152F of the sealing system 150F comprises a mechanical gasket member, such as an O-ring 802. The O-ring 802 may be configured to surround the access port 108 of the enclosure 102, as disclosed herein. The secondary seal 152F may further comprise a channel 804 formed within the cover 154F (e.g., on an inner surface of the cover 154F), the channel 804 configured to mate and/or physically engage the O-ring 802 when the cover 154F is sealed over the access port 108. Alternatively, the channel 804 may be formed on the body 104 (e.g., on an outer surface of the body 104), on both the body 104 and cover 154F, or the like.

Referring to FIG. 8B, the enclosure 102 is in a closed, vacuum sealed state. The primary seal 151F may be formed by welding the outside edge of the cover 154F to the body 104. The secondary seal 152F may be maintained, and protect the interior volume 106 from contamination, during removal of the primary seal 151F by engagement between overlapping surfaces of the cover 154F and body 104, and/or engagement between O-ring 802, the channel 804, and the body 104.

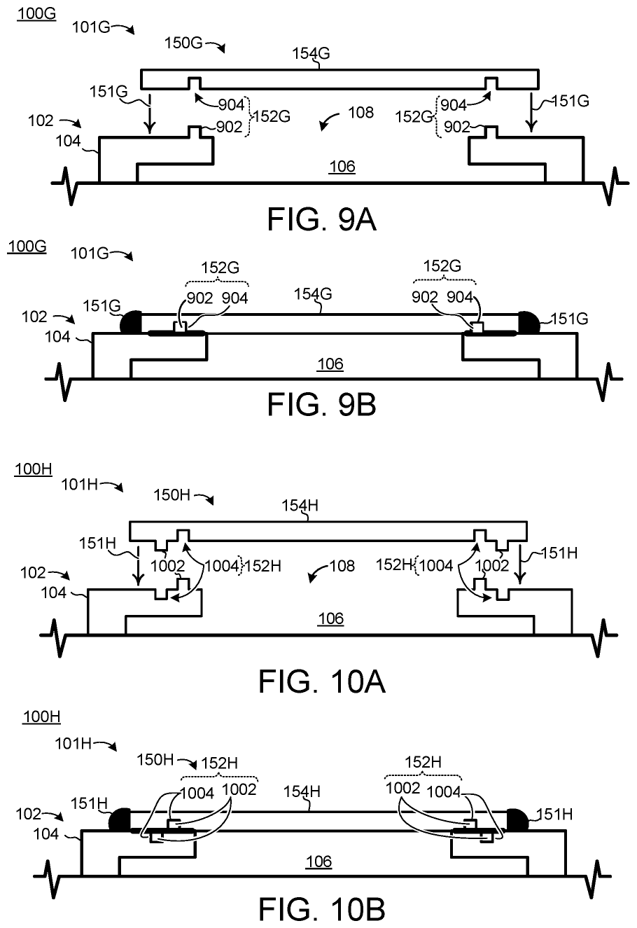

FIGS. 9A-10B illustrate examples of x-ray devices with an overlapping channeled cover of an access port with a protrusion according to some embodiments. Referring to FIGS. 9A-9B, a system 100G including an x-ray device 101G may be similar to systems 100 and 100A-F described above, including similar components. The secondary seal 152G of the sealing system 150G comprises a protrusion 902. The protrusion 902 may extend around the access port 108 of the enclosure 102 and be formed on an outer surface of the body 104. The secondary seal 152G may further comprise a channel 904 formed within the cover 154G (e.g., on an inner surface of the cover 154G), the channel 904 configured to mate and/or physically engage the protrusion 902 when the cover 154G is sealed over the access port 108.

Referring to FIG. 9B, the enclosure 102 is in a closed, vacuum sealed state. The primary seal 151G may be formed by welding the outside edge of the cover 154G to the body 104. The secondary seal 152G may be maintained, and protect the interior volume 106 from contamination, during removal of the primary seal 151G by engagement between overlapping surfaces of the cover 154G and body 104, and/or engagement between the protrusion 902 and the channel 904.

Referring to, FIGS. 10A-10B a system 100H including x-ray device 101H may be similar to systems 100 and 100A-G described above, including similar components. The secondary seal 152H of the sealing system 150H comprises corresponding protrusions 1002 and channels 1004 formed on the body 104 and cover 154H, respectively. The protrusions 1002 may be configured to mate and/or physically engage with corresponding channels 1004 when the cover 154H is placed over the access port 108 of the enclosure 102, as illustrated in FIG. 10B. The primary seal 151H may be formed by welding the outside edge of the cover 154H to the body 104. The secondary seal 152H may shield the interior volume 106 from contamination during removal of the primary seal 151H through physical engagement between overlapping surfaces of the cover 154H and body 104, and/or engagement between the protrusions 1002 and corresponding channels 1004. In some embodiments, the secondary seal 152H may comprise additional temporary or short-term seal mechanisms, such as a sealant or adhesive disposed on the overlapping surfaces, protrusions 1002, and/or channels, a gasket, an O-ring, and/or the like.

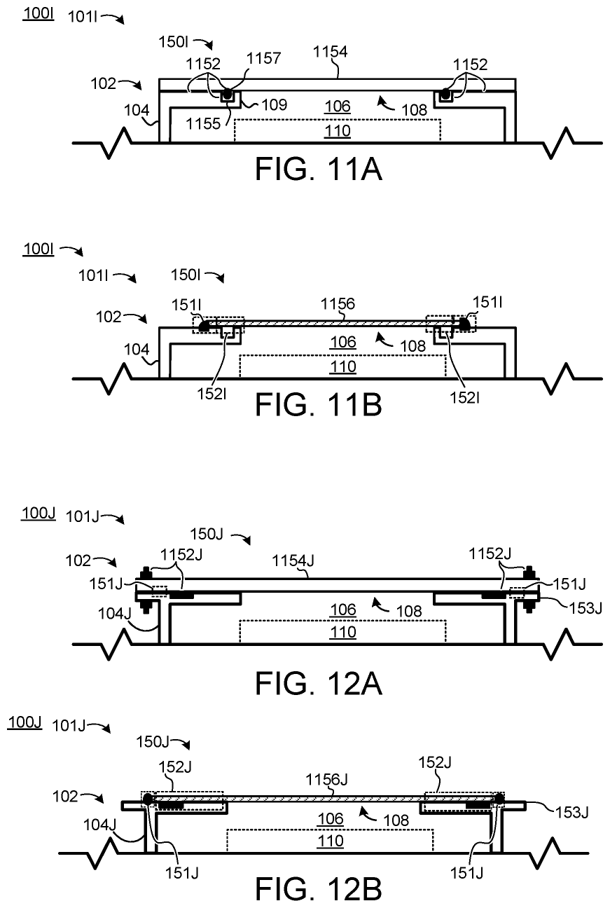

FIGS. 11A-12B illustrate examples of protective resealable vacuum sealing systems for x-ray device enclosures with access ports. Referring to FIGS. 11A-11B, the system 100I including x-ray device 101I may be similar to systems 100 and 100A-H described above, including similar components. The sealing system 150I comprises a releasable vacuum seal 1152 configured to vacuum seal the access port 108 of the enclosure 102. The releasable vacuum seal 1152 may comprise one or more releasable, temporary, short-term, removable, non-debris-producing or safe-removal seal mechanisms such as mechanical sealing mechanisms, gaskets, braze gasket, O-rings, sealant material, releasable adhesive, and/or the like. The releasable vacuum seal 1152 may be configured to vacuum seal the enclosure 102 independent of other seals and/or sealing mechanisms of the enclosure 102 and/or sealing system 150I (e.g., independent of a primary vacuum seal 151).

In some embodiments, the releasable vacuum seal 1152 may be configured to vacuum seal a temporary cover 1154 over the access port 108. The temporary cover 1154 may be adapted for validation test operations, as disclosed in further detail herein. Accordingly, validating testing of the x-ray device 101I and/or x-ray source 110 may proceed prior to and/or without the need for fabrication of a permanent or long-term vacuum seal, such as the primary seal 151I illustrated in FIG. 11B. The releasable vacuum seal 1152 may be capable of being removed without contaminating or otherwise damaging components within the interior volume 106 of the enclosure 102, such as the x-ray source 110 or the like. The sealing system 150I may, therefore, enable the x-ray device 101I and/or x-ray source 110 to recover from validation failures. In response to detection of a component failure, the releasable vacuum seal 1152 may be released, allowing the temporary cover 1154 to be removed, exposing the access port 108, the failed component may be repaired or replaced, and the releasable vacuum seal 1152 may be reapplied, without contaminating or otherwise damaging the x-ray source 110 within the interior volume 106 of the enclosure 102.

The releasable vacuum seal 1152 comprises a channel 1155 formed in the body 104 (e.g., around the perimeter 109 of the access port 108) and an O-ring 1157 configured to physically engage and/or mate with the channel 1155. The releasable vacuum seal 1152 may further comprise a physical engagement seal between overlapping surfaces of the temporary cover 1154 and the body 104 of the enclosure 102. In some embodiments, the overlapping surfaces may be adapted to facilitate and/or strengthen the releasable vacuum seal 1152, e.g., the surfaces may be roughened, comprise a sealant or adhesive, comprise additional physical engagement members, and/or the like. In some embodiments, the releasable vacuum seal 1152 may comprise one or more fasteners, such as a clamp, band, bolt, or the like (not shown in FIG. 11A to avoid obscuring details of the illustrated examples). The fasteners may be configured to secure the temporary cover 1154 over the access port 108 while vacuum is pulled within the interior volume 106 of the enclosure 102 and may be released or removed thereafter. Alternatively, the fasteners may be used to secure the temporary cover 1154 during validation testing.

As illustrated in FIG. 11B, the sealing system 150I may further comprise a primary seal 151I and a secondary seal 152I. The primary seal 151I may be configured to replace the releasable vacuum seal 1152 with a permanent, long-term vacuum seal. More specifically, the releasable vacuum seal 1152 (and temporary cover 1154) may be configured to be removed and replaced with the primary seal 151I and cover 1156, such as a production cover 1156. The releasable vacuum seal 1152 may be replaced by the primary seal 151I after successful validation testing of the x-ray device 101I or the constituent components. The primary seal 151I may comprise any suitable permanent or long-term sealing mechanism, as disclosed herein. The secondary seal 152I may be similar to the various secondary seals 152A-152H described herein.

In some embodiments, the temporary cover 1154 may be configured to facilitate validation testing of the x-ray source 110. For example, the temporary cover 1154 may comprise one or more testing and diagnostic components or capabilities, such as a temperature sensor, viewport or the like. The temporary cover 1154 may be used during validation testing of many different x-ray devices 101I (and/or enclosures 102). As such, the releasable vacuum seal 1152 and/or temporary cover 1154 may be adapted to endure numerous vacuum seal cycles. For example, the releasable vacuum seal 1152 may comprise high-endurance, heavy-duty vacuum seal components, the temporary cover 1154 may be formed from thick, high-strength materials, and so on (e.g., may be thicker, heavier, and/or more durable than the production cover 1156).

Referring to FIGS. 12A-B, a system 100J including x-ray device 101J may be similar to systems 100 and 100A-I described above, including similar components. The system 100J comprises a sealing system 150J comprising a releasable vacuum seal 1152J, a primary vacuum seal 151J, and a secondary seal 152J. The releasable vacuum seal 1152) may further comprise one or more fasteners configured to secure and/or clamp the temporary cover 1154) over the access port 108. The fasteners may comprise clamps, bolts, screws, clasps, clips, pins, ties, and/or the like that interface with a flange 153J of the body 104J. The releasable vacuum seal 1152) may be used to vacuum seal the enclosure 102 during validation testing of the x-ray device 101J (and/or x-ray source 110), as disclosed herein.

The releasable vacuum seal 1152) may be replaced with a primary seal 151J, as illustrated in FIG. 12B. A secondary seal 152J may be formed similar to the variety of ways of forming a secondary seal 152 and 152A-I described above and may be similar to or different from the releasable vacuum seal 1152J. In some embodiments, since the fasteners of the releasable vacuum seal 1152) would be disposed outside the primary seal 151J relative to the access port 108 (as opposed to between the primary seal 151J and access port 108), the fasteners may be excluded from the secondary seal 152J.

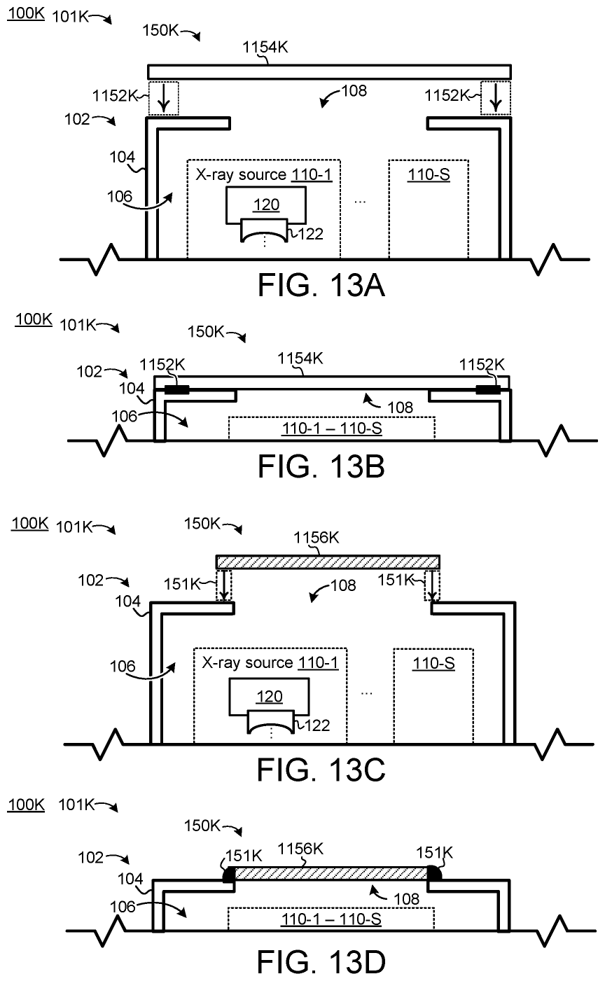

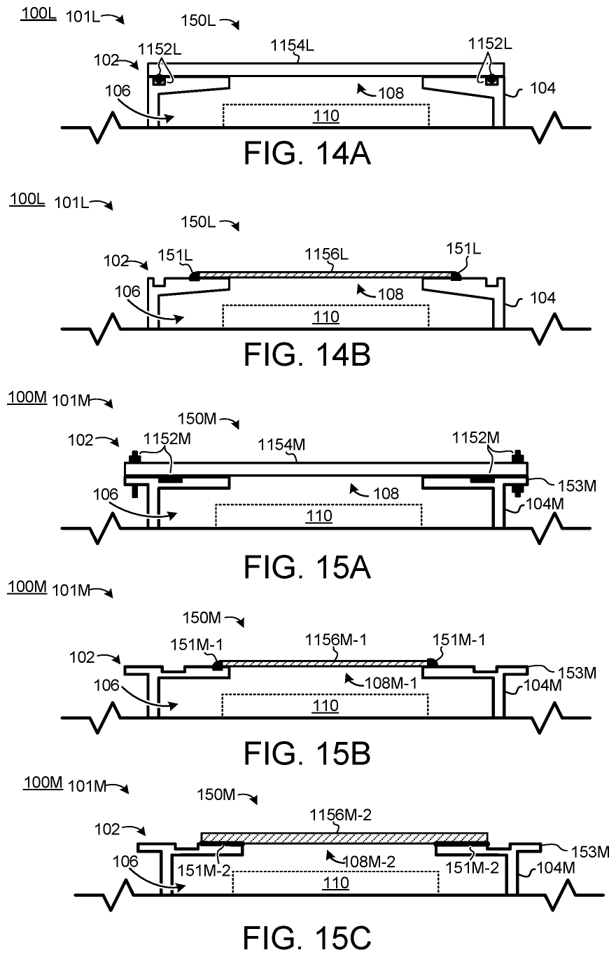

FIGS. 13A-16C illustrate examples of temporary protective vacuum sealing systems for x-ray device enclosures with access ports. The systems 100K-N may be similar to the systems 100 and 100A-J described above, with similar components. For example, the temporary covers 1154K-N and releasable vacuum seals 1152K-N may be similar to the releasable vacuum seals 1152 and 1152) or the like. The covers 1156K-N may be similar to the covers 154, 154A-H, 1156 and 11564 or the like. However, in some embodiments, a secondary seal similar to secondary seals 152 and 152A-J may be omitted.

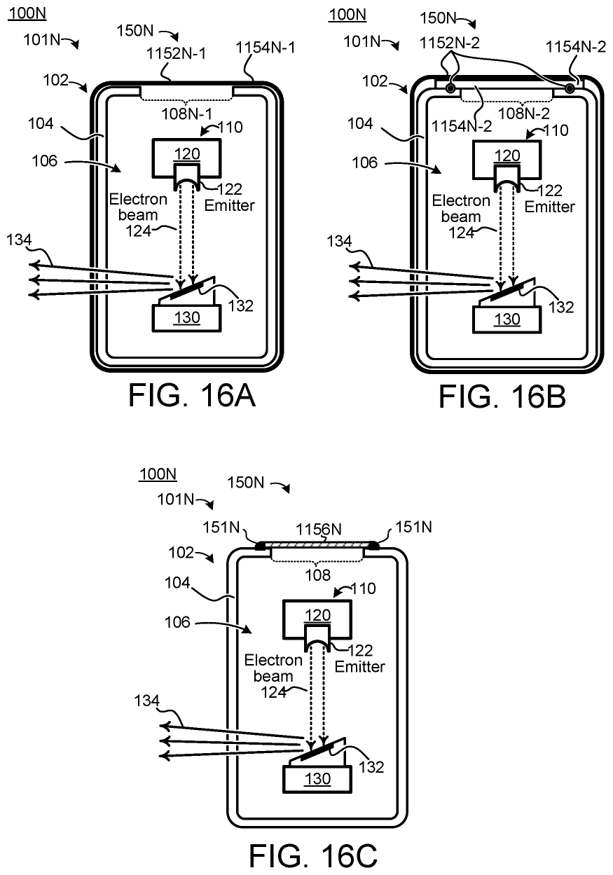

Referring to FIGS. 15A-16C, in some embodiments, the systems 100M or 100N may include different types of access ports 108M-1 to 108M-2 and covers 1156M-1 and 1156M-2 (illustrated in FIGS. 15B and 15C) or access ports 108N-1 and 108N-2 (illustrated in FIGS. 16A and 16B). Multiple temporary covers 1154M or 1154N and multiple covers 1156M or 1156N may be used with those multiple access ports 108. While two covers 1156M or 1156N have been used as an example, in other embodiments, the number of access ports 108 and the corresponding number of covers 1156M or 1156N may be greater than two.

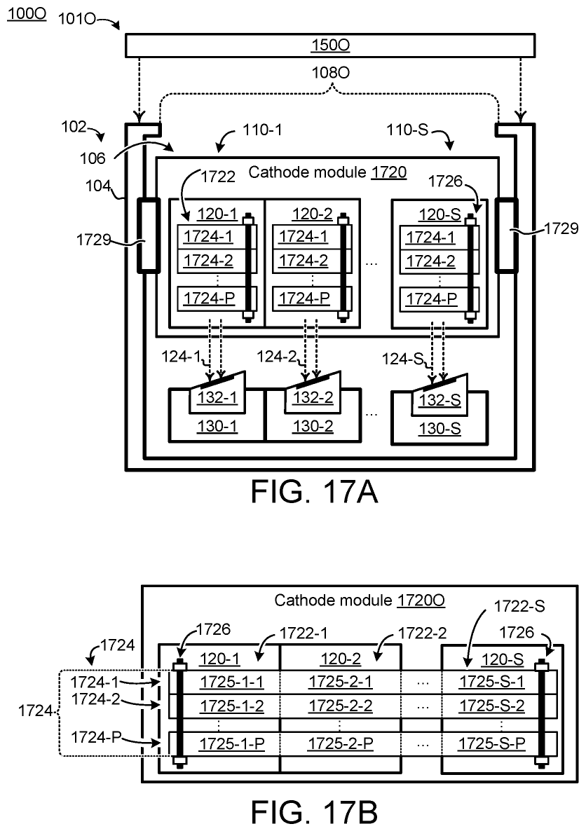

FIGS. 17A-17B illustrate examples of protective vacuum sealing systems for multi-emitter x-ray devices within an enclosure. Referring to FIGS. 17A and 17B, a system 1000 including x-ray device 1010 may be similar to the systems 100 and 100A-N or the like, including similar components. In some embodiments, x-ray device 1010 may include multiple x-ray sources 110-1 to 110-S, each including a respective cathode 120 and anode 130. Here, S x-ray sources 110 where S is an integer greater than one.

The cathodes 120 may each include cathode stacks 1722 with each cathode stack 1722 comprising multiple plates 1724. Each cathode 120 may comprise P plates 1724-1 through 1724-P in an aligned vertical stack configuration; however, the plates 1724 may have any suitable physical arrangement, configuration, or alignment. The plates 1724 may include electrodes, grids, mesh, spacers, emitters, dielectrics, insulators, or the like.

Due to space constraints and other factors, precisely aligning the plates 1724 of the cathodes 120 within the enclosure 102 may be difficult. The x-ray device 1010 may include one or more cathode modules 1720, each cathode module 1720 comprising one or more cathodes 120. Although one cathode module 1720 is used as an example, in other embodiments, the x-ray device 1010 may include any number of cathode modules 1720, each with one or more cathodes 120, including different numbers of cathodes 120 for different cathode modules 1720.

The cathode module 1720 may be assembled prior to installation within the enclosure 102. More specifically, the cathodes 120-1 through 120-S may be preassembled within the cathode module 1720 prior to installation of the cathode module 1720 into the interior volume 106. As used herein, a preassembled cathode 120 refers to a cathode having a plurality of plates 1724, and/or other components, secured in a specified alignment, e.g., plates 1724-1 through 1724-P secured in an aligned stack or the like. In some embodiments, the plates 1724-1 through 1720-P of each cathode 120-1 through 120-S may be secured in a specified alignment within the cathode module 1720 by fasteners 1726, such as screws, bolts, rivets, pins, or the like. The disclosure is not limited in this regard.

In some embodiments, cathodes 120 may be implemented on respective portions or sections of the plates 1724. For example, the cathode stacks 1722-1 to 17220S may share plates 1724-1 through 1724-P. The cathodes 120 be implemented on respective stacks 1722 of plates 1724. For example, stack 1722-1 of cathode 120-1 may comprise sections 1725-1-1 through 1725-1-P of plates 1724-1 through 1724-P, stack 1722-2 of cathode 120-2 may comprise sections 1725-2-1 through 1725-2-P, stack 1722-S of cathode 120-S may comprise sections 1725-S-1 through 1725-S-P, and so on. The cathode plates 1724-1 through 1724-P, and stacks 1722 of the corresponding cathodes 120-1 through 120-S, may be secured in a particular alignment by fasteners 1726. While cathodes 120 sharing every plate 1724 has been used as an example, in other embodiments, less than all, including only one of the plates 1724 may be shared between cathodes 120.

During operations, selected cathodes 120 may be configured to produce electron beams 124, which may be directed to targets 132 of corresponding anodes 130. Accurate targeting of the electron beams 124 may be predicated on precise alignment between cathodes 120 and corresponding anodes 130 (and precise alignment of the cathode stacks 1722 themselves). However, due to space constraints and other issues, precisely aligning the cathodes 120 within the enclosure 102 may be difficult. To address these and other issues, the cathode module 1720 and/or enclosure 102 may comprise a cathode mount 1729. The cathode mount 1729 may be configured to set the position, orientation, and/or alignment of the cathode module 1720, and corresponding preassembled cathodes 120-1 through 120-S, within the enclosure 102. The cathode mount 1729 may be configured to precisely align the position and/or orientation of the electron beams 124 produced by respective cathodes 120 with corresponding targets 132. In some embodiments, the cathode mount 1729 is configured to securely fix the position, orientation, and/or alignment of the cathode module 1720 (and/or corresponding cathodes 120-1 through 120-S). Alternatively, or in addition, the cathode mount 1729 may be configured to provide for precisely adjusting the position, orientation, and/or alignment while within the cathode module 1720 is disposed and/or sealed within the enclosure 102. The cathode mount 1729 can include fasteners, similar to fasters 1726 used to secure the cathode stacks 1722 to the support structure 1920, flanges, portions of the body 104 or enclosure 102, insulating standoffs, or the like.

The enclosure 102 may comprise an access port 108, which may be selectively vacuum sealed by use of a sealing system 1500. The sealing system 1500 may comprise one or more of the protective vacuum sealing systems 150 disclosed herein such as the protective vacuum sealing systems 150A through 150H illustrated in FIGS. 1 through 10B, the protective vacuum sealing systems 150I through 150N illustrated in FIGS. 11A through 16C, or the like including the various releasable vacuum seals 1152.

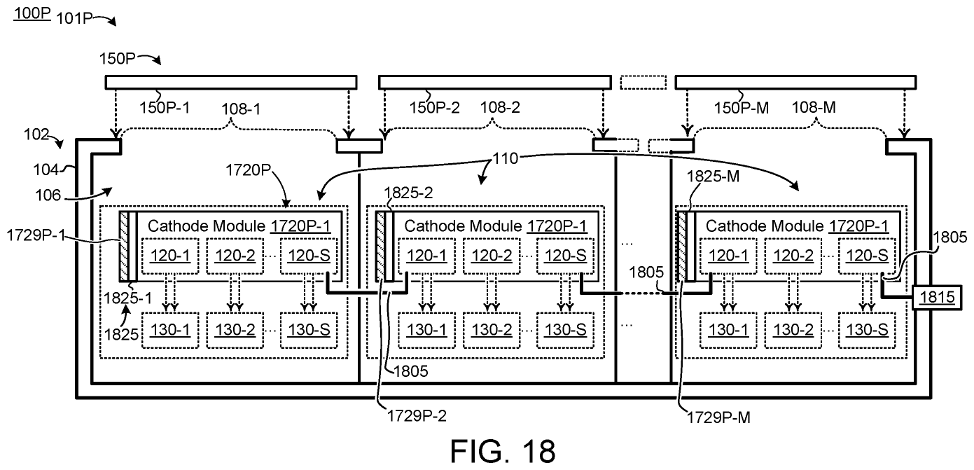

FIG. 18 illustrates examples of protective vacuum sealing systems for multi-emitter x-ray devices within an enclosure with multiple access ports. In some embodiments, a system 100P including x-ray device 101P may be similar to the systems 100 and 100A-O or the like, including similar components. The x-ray device 110P may comprise multiple cathode modules 1720P-1 through 1720P-M where M is any integer greater than one including cathodes 120 corresponding to anodes 130. The x-ray source 110 may, therefore, comprise M×S x-ray sources capable of generating M×S x-ray radiation beams.

The enclosure 102 may comprise M access ports 108-1 to 108-M, each access port 108 configured to provide access to the interior volume 106. In some embodiments, the access ports 108 may be configured to correspond to and allow access to respective cathode modules 1720P and anodes 130. In some embodiments, the system 100P further comprises cathode mounts 1729P-1 through 1729P-M, which may be configured to fix the position, orientation, and/or alignment of respective cathode modules 1720P-1 through 1720P-M within the enclosure 102, as disclosed herein.

The sealing system 150P may be configured to vacuum seal each access port 108-1 through 108-M. The protective vacuum sealing systems 150P-1 through 150P-M may comprise one or more of the protective vacuum sealing systems 150, 150A-150N, or the like as disclosed herein.

The cathode modules 1720P-1 through 1720P-M may comprise respective electrical feedthroughs 1825-1 through 1825-M, respectively. The electrical feedthrough 1825 of a cathode module 1720P may be configured to provide electrical power, signals, control voltages, or the like to respective cathodes 120-1 through 120-S such as emitter voltages, grid voltages, or the like from a control system, voltage generator, or the like of the system 100P.

The system 100P may further comprise an internal electrical connections 1805, which may be coupled to each cathode module 1720P-1 through 1720P-M. The internal electrical connection 1805 may be coupled to respective cathodes 120 of each cathode module 1720P (e.g., in a daisy chain configuration, series connection, or the like). In some embodiments, the internal electrical connection 1805 comprises a common internal ground, which may be coupled to ground connections of each cathode 120 (e.g., may be coupled to a ground plate or the like). The internal electrical connection 1805 may be coupled to a common electrical feedthrough 1815 of the x-ray device 101P. Since the common electrical feedthrough 1815 is coupled to each cathode 120 by the internal electrical connections 1805 between cathode modules 1720, the common electrical feedthrough 1815 may be used to apply a common voltage to the cathodes 120-1 through 120-S of each cathode module 1720P-1 through 1720P-M. The common voltage may be applied even if one or more of the individual electrical feedthroughs 1825-1 through 1825-M thereof fail. The redundancy provided by the internal electrical connection 1805 and common electrical feedthrough 1815 may be used to extend the usable life of the x-ray source 110.

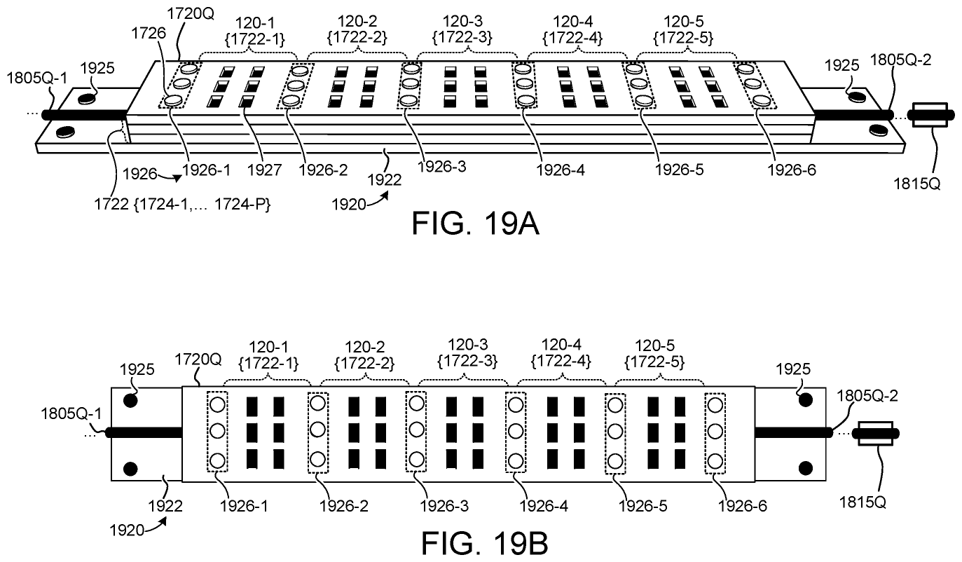

FIGS. 19A-19B illustrate examples of cathode modules with multiple fasteners according to some embodiments. FIGS. 19A and 19B illustrate top-front and top-down views of a cathode module 1720Q comprising cathode stacks 1722-1 through 1722-5. While five cathodes 120, each with six emitters 1927, are used as an example, in other embodiments, the number of cathodes 120 and/or number of emitters 1927 may be different. The cathodes 120 may be arranged in a substantially linear configuration. Internal electrical connections 1805Q-1 and 1805Q-2 may be coupled to respective cathodes 120, a common electrical feedthrough 1815, and/or one or more other cathode modules 1720 as described above.

The cathode stacks 1722 may be secured to a support structure 1920 of the cathode module 1720Q. The support structure 1920 may comprise any suitable mechanism for securing the cathode stack 1722 in a specified alignment, such as a substrate, layer, plate, panel, sheet, base, and/or the like. In some embodiments, the support structure 1920 may comprise a focus electrode 1922 of the cathode stack 1722. The focus electrode 1922 may be configured to focus and/or direct electron beams 124 produced by respective cathodes 120 to corresponding anodes 130. Cathode mounts 1925 may be configured to secure the cathode module 1720Q within an enclosure 102 (e.g., secure the cathode module 1720Q to a cathode mount 1729 within an enclosure 102, as disclosed herein). As will be described in further detail below, the cathode mounts 1925 may be configured to align the cathode module 1720Q with other components such as an anode 130.

In order to distribute clamping and/or other forces, the sides of respective cathode stacks 1722 may be secured by groups or sets of fasteners 1726 (fastener sets 1926). Each fastener set 1926 may be disposed between adjacent cathodes 120 of the cathode module 1720Q. The fasteners 1726 may be secured to the support structure 1920 through openings formed through the plates in the cathode stack 1722. The disclosure is not limited in this regard, however, and could utilize fastener sets 1926 comprising any suitable number of fasteners 1726 and/or fasteners 1726 of any suitable type. A suitable number of fasteners 1726 for the fastener sets 1926 may be determined to ensure consistent contact and/or load distribution along the sides of each cathode stack 1722, e.g., by testing, experience, simulation, design constraints, or the like.

The use of multiple fasteners 1726 can complicate manufacturing and lead to defects. Drilling and tapping precisely aligned openings (e.g., screw holes) for each fastener 1726 of each fastener set 1926-1 through 1926-6 may be difficult. Moreover, installing and tightening each of fasteners 1726 to a suitable torque while maintaining cathode alignment, and avoiding damage, can be tedious and time-consuming.

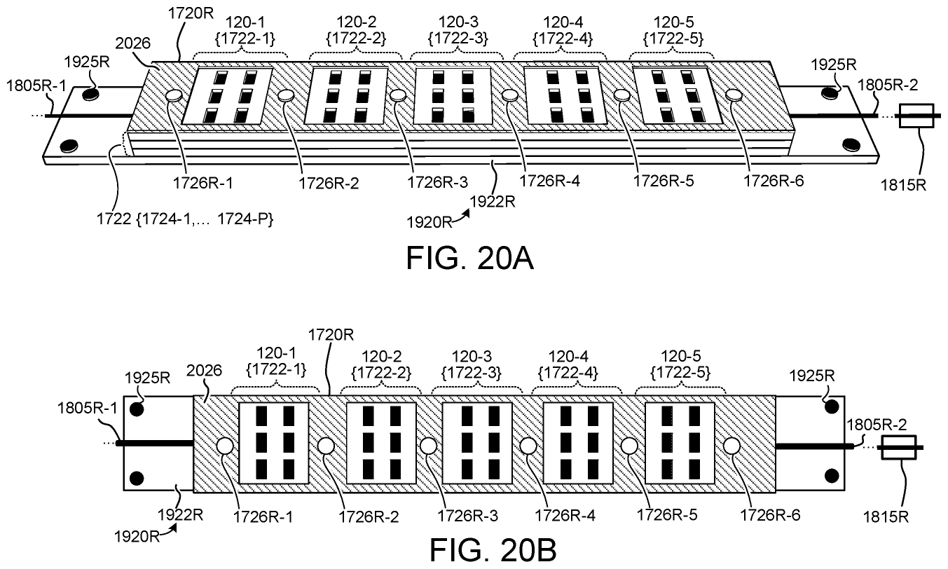

FIGS. 20A-22B illustrate examples of cathode modules with at least one compression plate according to some embodiments. Compression plate(s) 2026 may be configured to provide consistent contact along the sides of respective cathode stacks 1722, and distribute clamping and other forces, while reducing the quantity of fasteners 1726 used to secure the respective cathode stacks 1722 to the support structure 1920 with a desired precision.

Referring to FIGS. 20A and 20B, the cathode module 1720R may be similar to the cathode modules 1720 described above. The cathode stack 1722 of the cathode module 1720R may be secured and/or clamped to a support structure 1920R by a compression plate 2026. The compression plate 2026 may comprise a plate, a rigid plate, a compression plate, a sheet, a clamp, a panel, or the like. The compression plate 2026 may be configured to evenly distribute or increase the uniformity of the distribution of clamping load and/or force over respective sides of each cathode stack 1722. The compression plate 2026 may be configured to secure the cathode plates 1724-1 through 1724-P and/or cathode stacks 1722-1 through 1722-M in alignment with the focus electrode 1922R. The compression plate 2026 may be secured using a single opening and corresponding fastener 1726 disposed between adjacent cathodes 120 of the cathode module 1720R. For example, a single opening through the cathode stack 1722, and corresponding fastener 1726, may be disposed between each pair of adjacent cathodes 120 of the cathode module 1720R. In addition, a single opening and corresponding fastener 1726 may be disposed at respective ends of the cathode stacks 1722. Thus, a fastener 1726 is disposed adjacent to both sides of each cathode stack 1722.

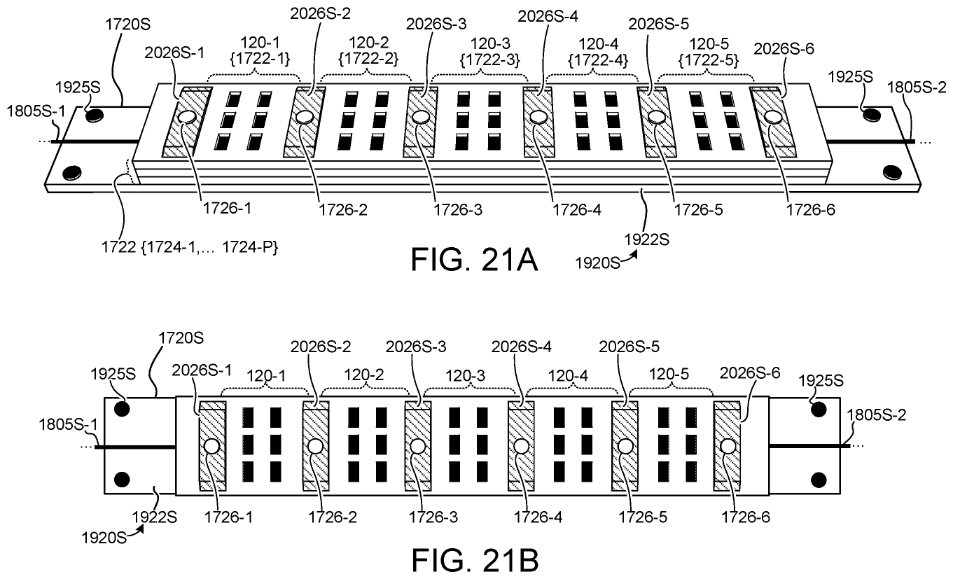

Referring to FIGS. 21A and 21B, the cathode module 1720S comprises multiple compression plates 2026S-1 through 2026S-6, each disposed along a side and/or between respective cathode stacks 1722 or cathodes 120 such that a compression plate 2026S is disposed adjacent to both sides of each cathode stack 1722. Each compression plate 2026S-1 through 2026S-6 may be secured and/or clamped to the support structure 1920S by one of the fasteners 1726-1 through 1726-6.

The compression plate(s) 2026 may reduce the quantity of fastener openings formed through the cathode stack 1722. The compression plate(s) 2026 may reduce the number of fastener openings needed to secure the cathode stacks 1722 of a cathode module 1720 by (F−1)×(S+1), where F is the number of fasteners 1726 needed to secure the cathode stacks 1722 without the benefit of compression plate(s) 2026 and S is the number of cathode stacks 1722 implemented by the cathode module 1720 (e.g., 6 fastener openings as compared to 18 fastener openings for F=3 and S=5 as in FIGS. 19A-21B). In various embodiments described herein, a single fastener 1726 may be disposed between the cathodes 120 due to the use of the compression plate(s) 2026 or the like. Accordingly, fewer openings and fasteners may be used in the cathode modules 1720.

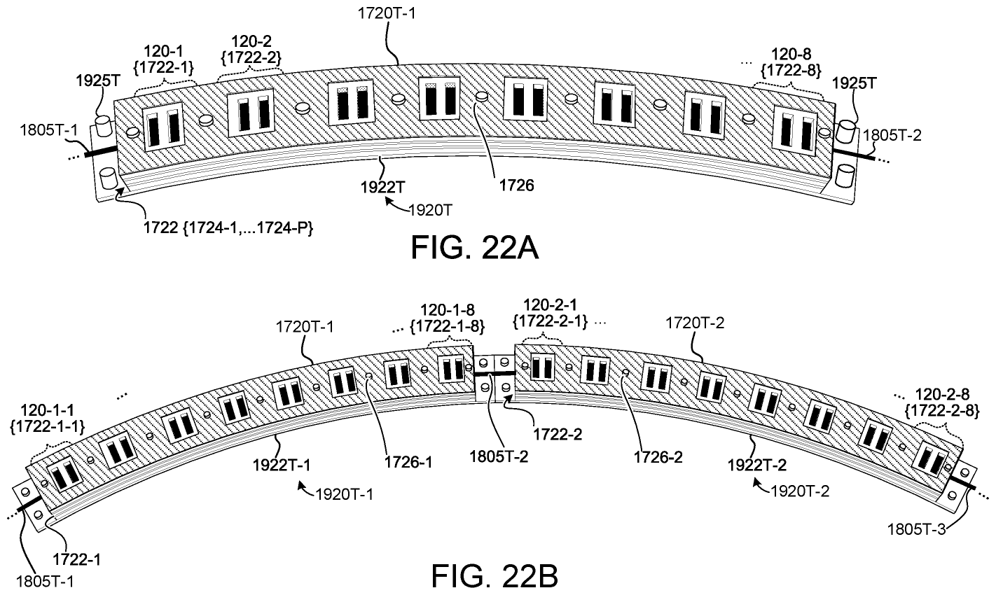

While a substantially linear or flat cathode module 1720 has been used as an example, in other embodiments, a cathode module 1720 may have a different configuration. Referring to FIGS. 22A-22B, in some embodiments, the cathode module 1720T may be configured to arrange cathodes 120-1 through 120-8 in a curve or arc. The cathode plates 1724-1 through 1724-P and corresponding focus electrode 1922T may be formed in a curve or arc, resulting in a corresponding cured or arced arrangement of respective cathodes 120 and cathode stacks 1722.

FIG. 22B illustrates an example of an x-ray source 110 comprising a plurality of cathode modules 1720T-1 and 1720T-2, each comprising respective cathodes 120-1-1 through 120-1-8 and 120-2-1 through 120-2-8. The cathode modules 1720T-1 and 1720T-2 may be coupled to an internal electrical connection 1805T-2. The cathode modules 1720T-1 and 1720T-2 may be coupled to other cathode modules 1720 and/or a common electrical feedthrough 1815 by internal electrical connections 1805T-1 and/or 1805T-3.

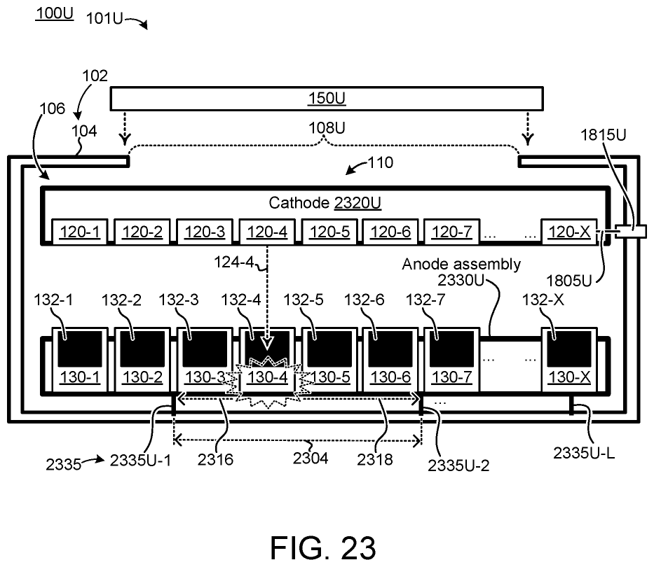

FIG. 23 illustrates an example of an x-ray device including an anode assembly according to some embodiments. A system 100U may be similar to systems 100, 100A-P, or the like described above, including similar components. The x-ray device 101U may include a cathode 2320U including the various cathodes 120, cathode modules 1720, or the like as described above. The x-ray device 101U includes an anode assembly 2330 comprising corresponding anodes 130. X cathodes 120 and anodes 130 may be part of the x-ray device 101U where X is an integer greater than one.

During operation, electrons emitted by selected cathodes 120 of the x-ray source 110 are directed towards targets 132 of corresponding anodes 130. The electrons may be accelerated into electron beams 124 by a voltage differential generated between the cathodes 120 and anodes 130. In order to maintain this voltage differential, the anodes 130 may be electrically isolated from the cathodes 120 and/or other components of the x-ray source 110, such as the body 104 of the enclosure 102. In some embodiments, the anode assembly 2330 may be secured within the enclosure 102 by a support 2335. The support 2335 may be further configured to electrically isolate the anode assembly 2330 from the enclosure 102 and/or other components of the x-ray source 110, e.g., may comprise non-conductive, electrically insulating materials, such as ceramic, ceramic-ceramic composites, porcelain, and/or the like. In some embodiments, the support 2335 may be configured to provide cooling to the anode assembly 2330, such as in U.S. patent application Ser. No. 17/173,036, filed Feb. 10, 2021, the contents of which are incorporated herein in its entirety.

The anode assembly 2330U is secured within the enclosure 102 by L supports 2335U-1 through 2335U-L to maintain the anodes 130 in alignment with each other and/or other components of the x-ray source 110. In some embodiments, the anode assembly 2330U may comprise 96 anodes 130 and may be secured within the enclosure 102 by 8 supports 2335U (e.g., X=96 and L=8). The supports 2335U-1 through 2335U-L may be arranged in any suitable manner. In some embodiments, the supports 2335U may be separated by an offset distance 2304, e.g., each support 2335U may be separated from adjacent supports 2335U by the offset distance 2304.

The use of multiple supports 2335U and/or other points of physical contact with the enclosure 102 can have significant disadvantages. Thermal expansion of the anode assembly 2330U may strain structural elements of the x-ray device 101U, which may lead to damage or even structural failure. For example, when an anode 130 is targeted by an electron beam 124, a significant portion of the corresponding energy may be converted into heat (e.g., 90% or more). For example, an electron beam 124-4 may heat the anode 130-4, resulting in thermal expansion of the anode assembly 2330U in directions 2316 and 2318. This thermal expansion may increase the effective length of the anode assembly 2330U, thereby forcing supports 2335U-1 and 2335U-2 further apart. Thermal expansion of the anode assembly 2330U during operation may, therefore, strain or even break structural elements, such as one or more anode supports 2335U, the body 104 of the enclosure 102, the anode assembly 2330U itself, and so on. Moreover, mitigating the adverse effects of thermal expansion through the use of flexible mounting mechanisms may not be feasible. For example, flexible support mechanisms may be unsuitable for adequately stabilizing and/or securing anodes 130 in alignment with corresponding cathodes 120. These and other issues may be addressed by segmentation of the anode assembly 2330.

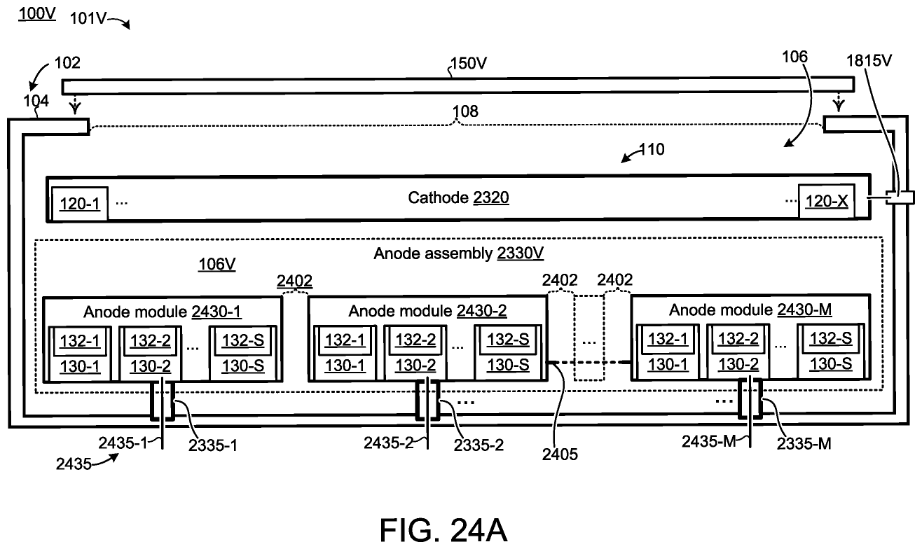

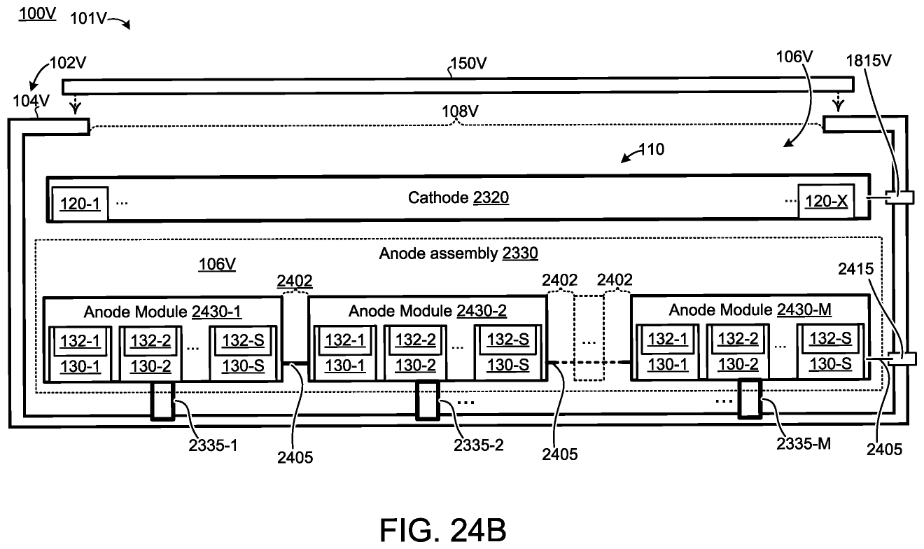

FIGS. 24A-24B illustrate examples of an x-ray device with segmented anode assemblies according to some embodiments. The system 100V may be similar to the system 100U described above. However, the anode assembly 2330V includes multiple structurally independent anode modules 2430. The anode assembly 2330V illustrated in FIG. 24A comprises X anodes 130 distributed across M structurally independent anode modules 2430-1 through 2430-M. Each of the M anode modules 2430 of the anode assembly 2330 may comprise a respective subset of the X anodes 130. In some embodiments the number of anodes 130 may be the same for each anode module 2430 while in others the number may be different.

The anode modules 2430 of the anode assembly 2330V may be configured to be structurally independent. In other words, each of the anode modules 2430 of the anode assembly 2330 may be secured and/or stabilized within the enclosure 102 independently of any of the other anode modules 2430 of the anode assembly 2330. In some embodiments, each anode module 2430 may be supported in the enclosure 102 by a single support 2335. Each of the supports 2335 may be structurally independent of any other(s) of the supports 2335. While a single support 2335 is illustrated, in some embodiments, one to all of the anode modules 2430 may each be supported with multiple supports 2335.

In some embodiments, the anode modules 2430 may be physical separated from one another by gaps 2402. The gaps 2402 may structurally isolate each anode module 2430 from adjacent anode modules 2430. The gaps 2402 may be configured such that thermal expansion of one or more of the anode modules 2430 does not contact or otherwise impose structural forces or strain on other anode modules 2430 and hence, the supports 2335 and the enclosure 102. The size of the gaps 2402 may correspond to a maximum extent of thermal expansion of an anode module 2430, which may be determined by testing, experience, simulation, design considerations, and/or the like. For example, an operating temperature range may include from about 25 degrees Celsius (° C.) to about 1100° C. A gap 2402 over such a range of temperatures may include from about 0.1 millimeters (mm) to about 10 mm.

In some embodiments, the supports 2335 may include feedthroughs 2435. During operation, the feedthroughs 2435 may be configured to maintain a voltage differential between the anode modules 2430 and other components such as the cathodes 120.

In some embodiments, the anode modules 2430 may be coupled to a common anode feedthrough 2415 by flexible internal electrical connection(s) 2405, as illustrated in FIG. 24A or 24B. The flexible internal electrical connections 2405 may be configured to preserve the structural independence of the anode modules 2430; the flexible internal electrical connections 2405 may, for example, comprise flexible and/or non-structural components, such as cables, ribbons, ribbon cables, flexible wiring, flexible conduit, and/or the like. In some embodiments, the supports 2335 may not include the feedthroughs 2435.

Although a single access port 108 has been used as an example in FIGS. 23-24B, in some embodiments, multiple access ports 108 may be present similar to the multiple access ports 108-1 to 108-M, 108-1 to 108-N, or the like.

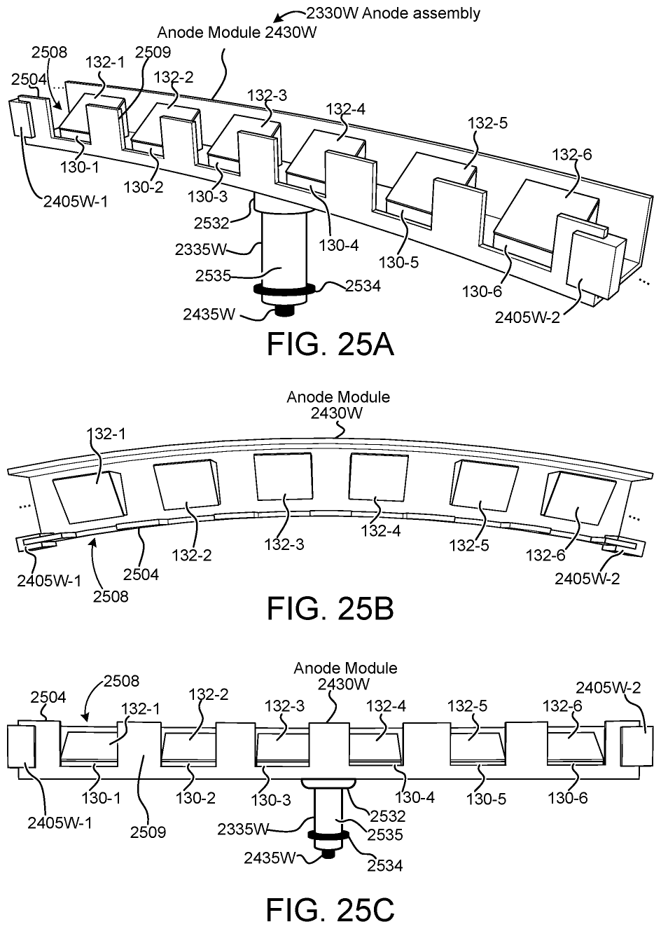

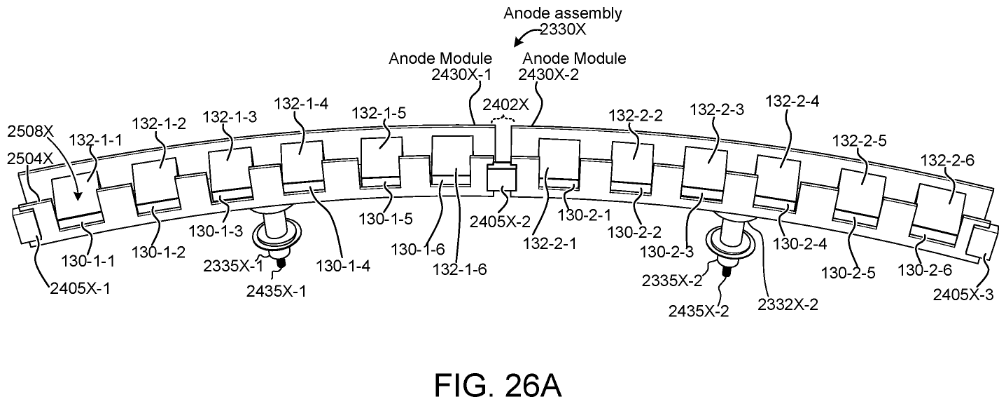

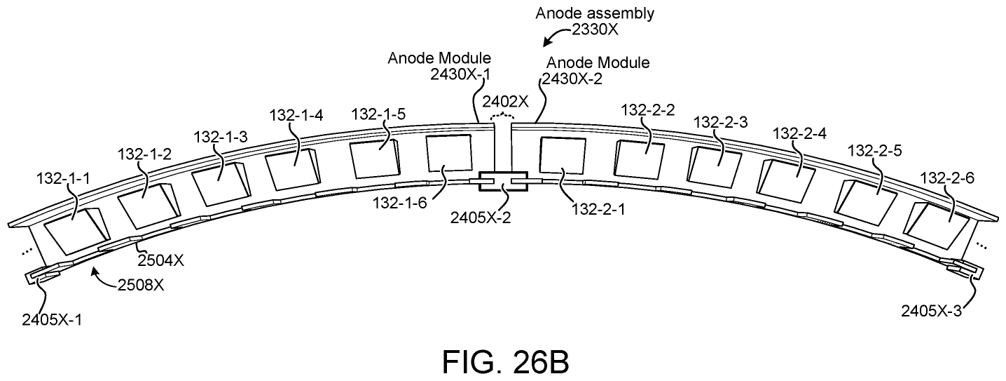

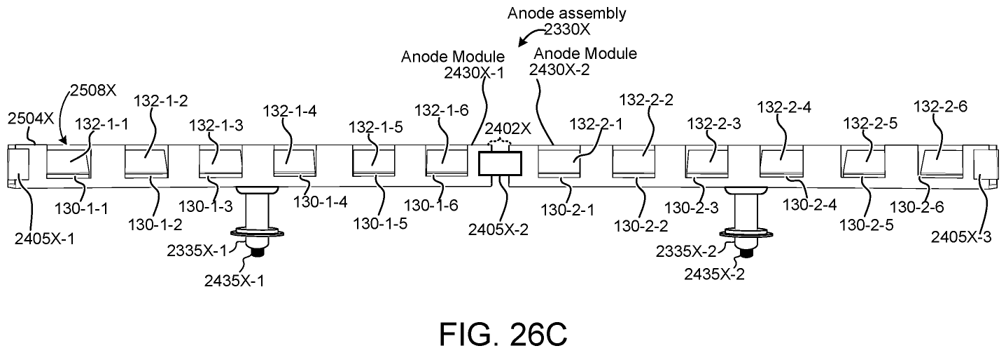

Although anode assemblies 2330 have been illustrated as substantially linear or flat, in other embodiments anode assemblies 2330 may be in different configurations or orientations. FIGS. 25A-26C illustrate examples of segmented anode assemblies according to some embodiments. FIGS. 25A-C are perspective, top-down, and front views of embodiments of an anode module 2430W configured to arrange anodes 130-1 through 130-6 in a curve or arc. A body 2504 of the anode module 2430W may comprise guide openings 2508 that form collimators 2509 configured to direct x-ray radiation 134 emitted from respective targets 132-1 through 132-6 in designated directions.

The support 2335W may be similar to the support 2335 described above. A collar 2532 of the support 2335W may be attached to the body 2504 of the anode module 2430W (e.g., by welding, brazing, or the like). The body 2535 of the support 2335W may comprise non-conductive, electrically insulating materials, as disclosed herein such as a ceramic support member, such as a ceramic column, cylinder, or other suitable structure. An attachment member 2534 of the support 2335W may be configured to be mounted within an enclosure 102, e.g., may comprise threads, a bolt, a weld attachment, or the like. In some embodiments, the anode module 2430W further comprises an anode feedthrough 2435W, which may be formed within or through the support 2335W. Alternatively, or in addition, the anode module 2430W may be electrically coupled to a common anode feedthrough 2415 by one or more flexible internal electrical connections 2405W-1 and/or 2405W-2, which may be configured to maintain the structural independence of the anode module 2430W, as disclosed herein.

FIGS. 26A-26C illustrate examples of an anode assembly 2330X comprising two or more anode modules 2430X, including 2430X-1 and 2430X-2, with each anode module 2430X being similar to anode modules 2430 or 2430W. In some embodiments, each anode module 2430X comprises a respective anode feedthrough 2435X. Alternatively, or in addition, the anode modules 2430X may be electrically interconnected by one or more flexible internal electrical connections 2405X-1 through 2405X-3, as disclosed herein.

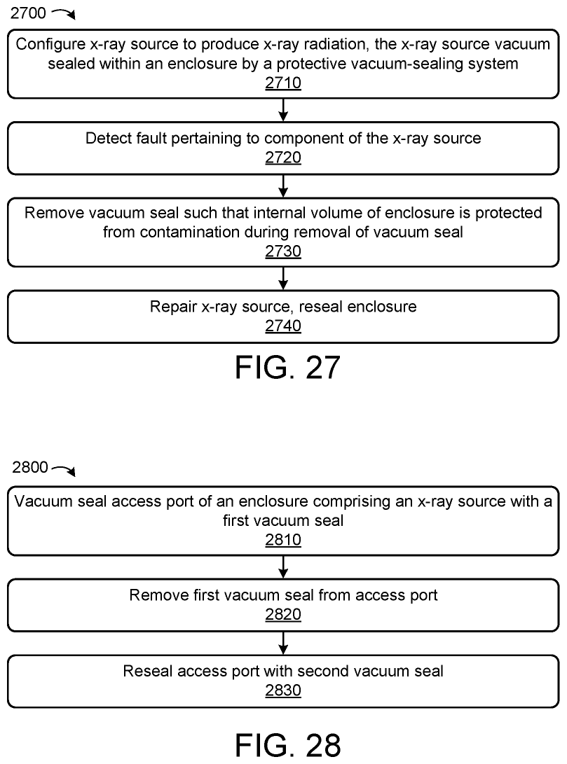

FIG. 27 is a flow diagram of an example of a method 2700 for operating an x-ray source 110 of an x-ray device 101. The method 2700, and the other methods disclosed herein, may be implemented by one or more of the systems 100 and/or 100A-X, x-ray devices 101 and/or 101A-X, and/or sealing systems 150 and/or 150A-V, disclosed herein (and/or variants thereof). At 2710, the x-ray source 110 may be configured to produce x-ray radiation 134, as disclosed herein. During operation in 2710, components of the x-ray source 110 may be vacuum sealed within an enclosure 102 by a sealing system 150. The sealing system 150 may be configured to vacuum seal an access port 108 of the enclosure 102. In some embodiments, the x-ray source 110 may comprise one or more cathode modules 1720, each comprising one or more cathodes 120 (e.g., cathodes 120-1 through 120-S). The x-ray source 110 may further comprise an anode assembly 2330 comprising a plurality of structurally independent anode modules 2430, as disclosed herein.

At 2720, a fault pertaining to a component of the x-ray source 110 may be detected. The fault may pertain to a component of the cathode 120 of the x-ray source 110, such as an emitter 122 or the like.

At 2730, the sealing system 150 may be used to remove the primary vacuum seal 151 from the access port 108 while protecting the interior volume 106 of the enclosure 102 from contamination. In some embodiments, the sealing system 150 comprises a secondary seal 152 disposed between the primary seal 151 and access port 108, the secondary seal 152 configured to protect the interior volume 106 from contamination during removal of the primary seal 151. Alternatively, the enclosure 102 may be vacuum sealed by a releasable vacuum seal 1152 of the sealing system 150. The releasable vacuum seal 1152 may be removed at 2730 without contaminating the enclosure 102, as disclosed herein.

At 2740, the components associated with the fault detected at 2720 may be repaired and/or replaced through the access port 108 and the enclosure 102 may be resealed, as disclosed herein.

FIG. 28 is a flow diagram illustrating an example of a method 2800 for protective vacuum sealing. At 2810, an access port 108 of an enclosure 102 comprising an x-ray source 110 may be vacuum sealed by a first vacuum seal 151 and corresponding secondary seal 152. At 2810, a first cover 154 may be sealed over the access port 108 by a primary vacuum seal 151 and a secondary seal 152 may be disposed between the primary vacuum seal 151 and the interior volume 106 of the enclosure 102. The primary seal 151 may comprise a permanent, long-term seal, such as a weld, permanent bond, or the like. Alternatively, the first vacuum seal may comprise a releasable vacuum seal 1152, the releasable vacuum seal 1152 configured to seal a temporary cover 1154 over the access port 108, as disclosed herein.

At 2820, the first vacuum seal may be removed from the access port 108 of the enclosure 102. Removing the first vacuum seal 151 may further comprise protecting the interior volume 106 of the enclosure 102 from contamination during the removal with the secondary seal 152 as described above. In some embodiments, the interior volume 106 may be protected from contamination by a secondary seal 152 maintained between the primary vacuum seal 151 and access port 108. The primary vacuum seal 151 may be removed by milling or other debris-producing process(es) and the secondary seal 152 may be configured to block the resulting debris from contaminating the enclosure 102. Alternatively, the first vacuum seal may comprise a releasable seal 1152 configured to be removed without the use of any debris-producing-processes. The releasable seal 1152 may comprise one or more mechanical seals, as disclosed herein.

In some embodiments, the first vacuum seal may be removed at 2820 in response to a failure of a component of the x-ray source 110. The failed component may be identified during initial validation testing of the x-ray device 101, during use of the x-ray device 101 in a production environment, or the like.

At 2830, the access port 108 of the enclosure 102 may be resealed with a second vacuum seal. The access port 108 may be resealed in response to repairing and/or replacing one or more failed components of the x-ray source 110 through the access port 108 (e.g., in response to removing the first vacuum seal at 2820). The second vacuum seal may be configured to permanently seal a second cover 154 over the access port 108 (e.g., a production cover 1156). In some embodiments, the second vacuum seal comprises a primary vacuum seal 151 and a secondary seal (e.g., a secondary seal 152), as disclosed herein.

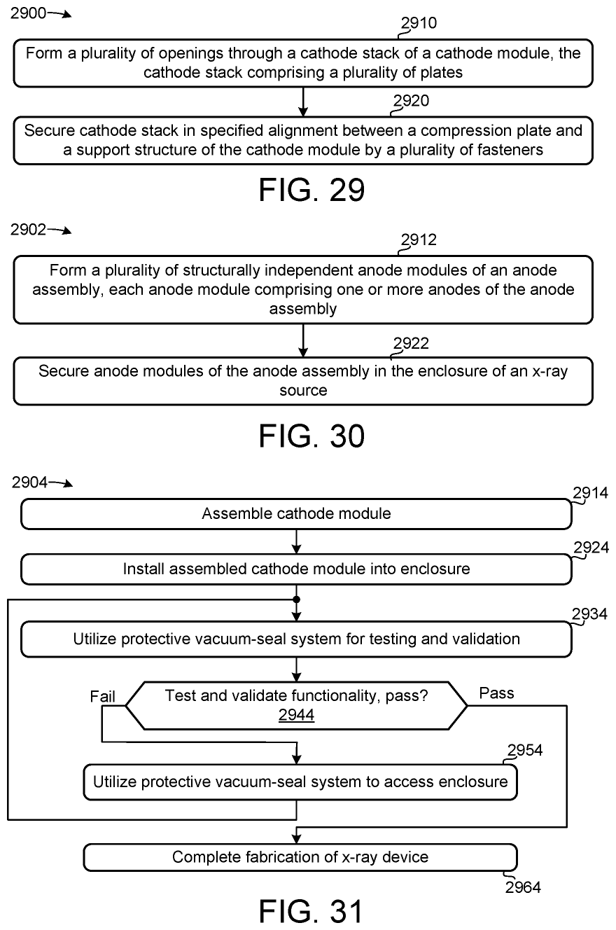

FIG. 29 is a flow diagram of an example of a method 2900 for manufacturing an x-ray device 101. At 2910-2920, a cathode module 1720 comprising a plurality of cathodes 120 may be assembled. At 2910, a plurality of openings may be formed through the cathode stack 1722 of the cathode module 1720. The openings may be formed through a plurality of plates 1724 comprising the cathode stack 1722, as disclosed herein. At 2920, the plurality of plates 1724 of the cathode stack 1722 may be secured in a specified alignment between a compression plate 2026 and a support structure 1920 of the cathode module 1720 by a plurality of fasteners 1726. The fasteners 1726 may be secure to the support structure 1920 through respective openings of the plurality of openings, as illustrated in FIGS. 20A-22B.

In some embodiments, the openings through the cathode stack 1722 are formed at 2910 such that a single opening is disposed between each adjacent pair of cathodes 120 of the plurality of cathodes 120 of the cathode module 1720. Assembling the cathode module 1720 may further comprise clamping the cathode stack between the compression plate 2026 and the support structure 1920 by the plurality of fasteners 1726. Alternatively, or in addition, the cathode stack 1722 may be clamped between the support structure 1920 and a plurality of compression plates 2026. In these embodiments, assembling the cathode module 1720 may further comprise clamping a respective compression plate 2026 between each adjacent pair of cathodes 120 by a single fastener 1726 secured to the support structure 1920 through the single opening disposed between the adjacent pair of cathodes 120. The assembled cathode module 1720 may be configured to be installed into the interior volume 106 of the enclosure 102 of the x-ray source 110 through an access port 108, as disclosed herein (e.g., the access port may be configured to receive the preassembled cathode module 1720 into the interior volume 106).

FIG. 30 is a flow diagram of another example of a method 2902 for manufacturing an x-ray device 101. The method 2902 may comprise forming an anode assembly 2330 comprising a plurality of anodes 130, the plurality of anodes 130 distributed across a plurality of structurally independent anode modules 2430. At 2912, a plurality of anode modules 2430 of the anode assembly 2330 may be formed, each anode module 2430 comprising one or more anodes 130 (e.g., each anode module 2430 comprising a respective subset of the anodes 130 of the anode assembly 2330). At 2922 each anode module 2430 of the anode assembly 2330 may be secured within the enclosure 102 of an x-ray source 110 by a respective singular support 2335 of a plurality of supports 2335, e.g., each anode module 2430 of the anode assembly 2330 formed at 2912 may be secured within the enclosure 102 by a separate, structurally independent support 2335, as disclosed herein. In some embodiments, respective anode modules 2430 of the anode assembly 2330 may be separated from other, adjacent anode modules 2430 by one or more gaps 2402, as disclosed herein.

In some embodiments, feedthroughs 2435 of the anode modules 2430 may be formed through the supports 2335. Alternatively, or in addition, the anode modules 2430 may be coupled to a common anode feedthrough 2515 by flexible internal electrical connections 2405, as disclosed herein.

FIG. 31 is a flow diagram of another example of a method 2904 for manufacturing an x-ray device 101. The method 2904 may comprise fabrication of an x-ray source 110 within a vacuum sealed enclosure 102. The method 2904 may further comprise validation testing of the x-ray source and/or recovery from validation failures, as disclosed herein. At 2914, a cathode module 1720 of the x-ray source 110 may be assembled prior to installation into the enclosure 102; 2914 may comprise preassembling the cathode module 1720 separately and/or independently of other components of the x-ray source 110. The cathode module 1720 may be assembled per method 2900 of FIG. 29.

At 2924, the assembled cathode module 1720 may be installed into the enclosure 102 of the x-ray source 110. The cathode module 1720 may be installed through an access port 108 of the enclosure 102. The assembled cathode module 1720 may be secured by a cathode mount 1729 and/or one or more cathode mounts 1925, as disclosed herein. The assembled cathode module 1720 may be installed in an end phase of the manufacturing process of the x-ray source 110. As used herein, an end phase refers to a phase of a manufacturing process that follows completion of one or more other phases or steps. For example, the preassembled cathode module 1720 may be installed following the anode assembly 2330 of the x-ray source 110, e.g., following completion of the anode assembly method 2902 of FIG. 30.

At 2934, the access port 108 of the enclosure 102 may be vacuum sealed by a sealing system 150, as disclosed herein. The sealing system 150 may comprise a primary vacuum seal 151 and secondary seal 152, the secondary seal 152 configured to protect the interior volume 106 from contamination during removal of the primary vacuum seal 151, as disclosed herein. Alternatively, the sealing system 150 may comprise a releasable vacuum seal 1152, as disclosed herein.

At 2944, functionality of the x-ray source 110 within the vacuum sealed enclosure 102 may be tested and/or validated. If the x-ray source 110 passes validation testing, the flow continues at 2964. If, however, one or more components of the x-ray source 110 fail the validation testing at 2944, the flow may continue at 2954. At 2954, the sealing system 150 may be used to repair or replace one or more component(s) of the x-ray source 110. In some embodiments, the vacuum seal over the access port 108 may be removed by breaching the primary seal 151 (e.g., by removing the cover 154 from the access port 108 in a debris-producing process). In these embodiments, the interior volume 106 of the enclosure 102 may be protected from contamination by the secondary seal 152. Alternatively, the access port 108 may be exposed by removing a releasable vacuum seal 1152, as disclosed herein. At 2954, the sealing system 150 may be further configured to reseal the enclosure 102 to enable testing and validation to resume at 2944. Resealing the access port 108 may comprise reforming the primary seal 151 (e.g., by welding a new cover 154 over the access port 108). Alternatively, the access port 108 may be vacuum sealed by a releasable vacuum seal 1152, as disclosed herein (e.g., by resealing a temporary cover 1154 over the access port 108).

At 2964, testing and validation of the x-ray source 110 may be successfully completed. The fabrication of the x-ray device 101 may be completed. In some embodiments, the primary seal 151 and corresponding secondary seal 152 formed by the sealing system 150 may be retained as the x-ray source 110 enters service. In other embodiments, the releasable vacuum seal 1152 may be removed and replaced with a primary vacuum seal 151. The primary vacuum seal 151 may be configured to vacuum seal a production cover 1156 over the access port 108 (replacing the temporary cover 1154 utilized during testing and validation).

In an embodiment, the number of fasteners 1726 used to secure the cathode stacks 1722 to the support structure 1920 of the assembled cathode module 1720 is greater than the number of the cathode mounts 1729, 1925 to attach, secure, or align the assembled cathode module 1720 within the enclosure 102 or to the body 104 of the enclosure 102. The number of fasteners 1726 used to secure the cathode stacks 1722 to the support structure 1920 of the assembled cathode module 1720 may be 2, 4, or 8 times greater than the number of the cathode mounts 1729, 1925 to attach, secure, or align the assembled cathode module 1720 within the enclosure 102 or to the body 104 of the enclosure 102.

An x-ray device 101 comprising: an access port 108, 108M, 108N configured to receive a cathode 120 within an interior volume of an enclosure 102 of the x-ray device 101; a first vacuum seal 151, 151A-N configured to seal a cover over the access port 108, 108M, 108N; and a second seal 152, 152A-J configured to seal the cover over the access port 108, 108M, 108N, the second seal 152, 152A-J maintained between the first vacuum seal 151, 151A-N and the interior volume of the enclosure 102 during removal of the first vacuum seal 151, 151A-N.

In some embodiments, the first vacuum seal 151, 151A-N is formed on a first path around the access port 108, 108M, 108N, and the second seal 152, 152A-J comprises a physical overlap between the cover and the enclosure 102 on a second path around the access port 108, 108M, 108N, the second path disposed between the first path and a perimeter of the access port.

In some embodiments, the access port 108, 108M, 108N is one of a plurality of access ports, each configured to receive a cathode 120 within the interior volume 106 of the enclosure 102 of the x-ray device 101.

In some embodiments, the secondary seal 152, 152A-J comprises a protrusion 1004 configured to mate with a channel 1002 formed within one or more of the outer surface of the enclosure 102 and the inner surface of the cover 154, 154A-H, 1154, 1154J-N.

In some embodiments, the x-ray device 101 further comprises a releasable mechanism 1152, 1152J-N configured to seal a temporary cover 1156, 1156J-N over the access port 108, 108M, 108N, wherein the first vacuum seal 151, 151A-N is configured to replace the releasable vacuum seal 1152, 1152J-N with a permanent vacuum seal.

In some embodiments, the cathode 120 is one of a plurality of cathodes 120 of the x-ray device 101; the access port 108, 108M, 108N is configured to receive a preassembled cathode module 1720, 17200-T comprising a plurality of cathodes 120, the preassembled cathodes comprising a cathode stack 1722 comprising a plurality of plates 1724 secured in a specified alignment.

In some embodiments, each of the cathodes 120 includes a plurality of emitters 1927.

In some embodiments, the x-ray device 101 further comprises: a plurality of openings formed through plurality of plates of the cathode stack 1722; a plurality of fasteners 1926 1926, each fastener 1926 secured to a support structure 1920 of the cathode module 1720, 17200-T through a respective opening of the plurality of openings formed through the cathode stack 1722; and a compression plate 2026, 2026S-T, wherein a single opening of the plurality of openings formed through the cathode stack 1722 is disposed between adjacent preassembled cathodes of the cathode module 1720, 17200-T, and wherein the fasteners 1926 are configured to secure the cathode stack 1722 between the compression plate 2026, 2026S-T and the support structure 1920.

In some embodiments, the x-ray device 101 further comprises: a plurality of cathode modules 1720, 17200-T, each cathode module 1720, 17200-T comprising one or more cathodes and a compression plate 2026, 2026S-T configured to secure a cathode stack 1722 of the one or more cathodes to a focus electrode; and at least one internal electrical connection coupled between the plurality of cathode modules 1720, 17200-T.

In some embodiments, the x-ray device 101 further comprises: an anode assembly comprising a plurality of anode modules 2430, 2430W-X, each anode module 2430, 2430W-X comprising one or more anodes; and a plurality of supports, each support configured to secure a respective one of the plurality of anode modules of the anode assembly within an interior volume of the enclosure 102 such that each anode module of the anode assembly is secured by a single support of the plurality of supports.

Some embodiments include a method, comprising: sealing an access port 108, 108M, 108N of an enclosure 102 with a first vacuum seal 151, 151A-N and a secondary seal 152, 152A-J, 1152, 1152J-N, the enclosure 102 having an interior volume comprising an x-ray source; removing the first vacuum seal 151, 151A-N from the access port 108, 108M, 108N of the enclosure, comprising protecting the interior volume of the enclosure 102 from contamination during removal of the first vacuum seal 151, 151A-N with the secondary seal 152, 152A-J, 1152, 1152J-N; and resealing the access port 108, 108M, 108N of the enclosure 102 with a first vacuum seal 151, 151A-N after the removal of the first vacuum seal 151, 151A-N.

In some embodiments, sealing the access port 108, 108M, 108N comprises: forming the secondary seal 152, 152A-J, 1152, 1152J-N between the first vacuum seal 151, 151A-N and the interior volume of the enclosure; and sealing a first cover over the access port 108, 108M, 108N with the first vacuum seal 151, 151A-N.

In some embodiments, resealing the access port 108, 108M, 108N further comprises reforming the secondary seal 152, 152A-J, 1152, 1152J-N.

In some embodiments, the first vacuum seal 151, 151A-N comprises a weld joining the cover to the enclosure, and wherein removing the first vacuum seal 151, 151A-N comprises milling the weld.

In some embodiments, the method further comprises, before sealing the access port 108, 108M, 108N of the enclosure 102 with the first vacuum seal 151, 151A-N and the secondary seal 152, 152A-J, 1152, 1152J-N: forming a releasable vacuum seal 1152, 1152J-N configured to seal a temporary cover over the access port 108, 108M, 108N; testing the x-ray source 110; removing the releasable vacuum seal 1152, 1152J-N; sealing the access port 108, 108M, 108N with the first vacuum seal 151, 151A-N after removing the releasable vacuum seal.

In some embodiments, the method further comprises: assembling a cathode module 1720, 17200-T comprising a plurality of cathodes 120, the cathodes 120 comprising a cathode stack 1722 comprising a plurality of plates 1724 secured in a specified alignment; and installing the assembled cathode module 1720, 17200-T into the interior volume of the enclosure 102 through the access port 108, 108M, 108N.

In some embodiments, assembling the cathode module 1720, 17200-T comprises: forming a plurality of openings through the cathode stack 1722 such that a single opening through the cathode stack 1722 is formed between each pair of adjacent cathodes of the cathode module 1720, 17200-T; and clamping one or more compression plates 2026, 2026S-T over the cathode stack 1722 by a plurality of fasteners 1926, each fastener 1926 installed through a respective opening of the plurality of openings. In some embodiments, minimal fasteners may be used to attach the cathode module 1720, 17200-T to the body 104 or enclosure 102.

In some embodiments, the method further comprises: forming an anode assembly 2330U-X comprising a plurality of anode modules 2430, 2430W-X, each anode module 2430, 2430W-X comprising one or more anodes 130; and mounting each anode module 2430, 2430W-X of the anode assembly 2330U-X within the enclosure 102 by a single support of a plurality of structurally independent supports.

Some embodiments include an x-ray device 101, comprising: means for generating x-rays; means for maintaining a vacuum around the means for generating x-rays, including: means for accessing an interior volume of the means for maintaining the vacuum around the means for generating x-rays; means for vacuum sealing the means for accessing the interior volume; and means for protecting the interior volume from contamination during removal of the means for vacuum sealing the means for accessing the interior volume.

Examples of the means for generating x-rays include the x-ray sources 110, cathodes 120, anodes 130, or the like. Examples of the means for maintaining a vacuum around the means for generating x-rays include the enclosure 102, body 104, covers 154, or the like. Examples of the means for accessing an interior volume of the means for maintaining the vacuum around the means for generating x-rays include the access ports 108, 108M, 108N, or the like. Examples of the means for vacuum sealing the means for accessing the interior volume include the first vacuum seals 151, 151A-N, or the like. Examples of the means for protecting the interior volume from contamination during removal of the means for vacuum sealing the means for accessing the interior volume include the secondary seals 152, 152A-J, 1152, 1152J-N or the like.

In some embodiments, the x-ray device 101 further comprises: means for temporarily vacuum sealing the means for accessing the interior volume before attaching the means for vacuum sealing the means for accessing the interior volume. Examples include the releasable vacuum seal 1152, 1152J-N temporary cover 1154, or the like.

Some embodiments include an x-ray device 101, comprising: an enclosure 102; an anode assembly 2330U-X comprising a plurality of anode modules 2430, 2430W-X 2430, 2430W-X, each anode module anodes 1302430, 2430W-X comprising one or more anodes 130; and a plurality of supports 2335, 2335W-X, each support 2335, 2335W-X configured to secure a respective anode module anodes 1302430, 2430W-X of the anode assembly 2330U-X within an interior volume of the enclosure 102 such that each anode module anodes 1302430, 2430W-X of the anode assembly 2330U-X is secured by a single support 2335, 2335W-X of the plurality of supports 2335, 2335W-X.

In some embodiments, each anode module anodes 1302430, 2430W-X of the anode assembly 2330U-X is structurally isolated from adjacent anode modules 2430, 2430W-X of the anode assembly 2330U-X by one or more gaps.

In some embodiments, the gaps are configured to structurally isolate each anode module anodes 1302430, 2430W-X of the anode assembly 2330U-X from thermal expansion of any other of the anode modules 2430, 2430W-X of the anode assembly 2330U-X during operation.

In some embodiments, the x-ray device 101 further comprises for each adjacent pair of anode modules 2430, 2430W-X of the anode modules 2430, 2430W-X 2430, 2430W-X, a flexible electrical connection electrically connecting the pair of anode modules 2430, 2430W-X together.

In some embodiments, the x-ray device 101 further comprises common electrical feedthrough penetrating the enclosure 102 and electrically connected to one of the anode modules 2430, 2430W-X.

In some embodiments, the supports are further configured to electrically isolate the anode modules 2430, 2430W-X of the anode assembly 2330U-X from at least one of the enclosure 102 and a cathode.

In some embodiments, the supports comprise ceramic supports.

In some embodiments, each anode module 2430, 2430W-X of the anode assembly 2330U-X comprises a respective feedthrough extending through the single support structure of the anode module 2430, 2430W-X.

In some embodiments, each anode module anodes 1302430, 2430W-X includes a plurality of targets 132.

Some embodiments include a method, comprising: mounting a plurality of anode modules 2430, 2430W-X within an enclosure 102 of an x-ray device 101 with a single support for each anode module 2430, 2430W-X, wherein: a gap is formed between adjacent anode modules 2430, 2430W-X 2430, 2430W-X; and each anode module 2430, 2430W-X includes at least one anode 130; electrically connecting through the enclosure 102 of the x-ray device 101 to each of the anode modules 2430, 2430W-X 2430, 2430W-X.

In some embodiments, the method further comprises electrically connecting adjacent anode modules 2430, 2430W-X together across the associated gap.

In some embodiments, the method further comprises for each anode module 2430, 2430W-X, electrically connecting to the anode module 2430, 2430W-X through the associated single support.

In some embodiments, the method further comprises electrically connecting to each of the anode modules 2430, 2430W-X through a single electrical feedthrough penetrating the enclosure 102 of the x-ray device 101.

Some embodiments include an x-ray device 101, comprising: means for containing a vacuum; means for generating electron beams; a plurality of separate means for generating x-rays within the vacuum; and for each of the separate means for generating x-rays within the vacuum, means for individually supporting the means for generating x-rays within the vacuum.

Examples of the means for containing a vacuum include the enclosure 102, the body 104, the covers 154, 154A-H, 1154, or the like. Examples of the means for generating electron beams include the cathodes 120, or the like. Examples of the separate means for generating x-rays within the vacuum include the anode modules 2430, 2430W-X 2430, 2430W-X or the like. Examples of the means for individually supporting the means for generating x-rays within the vacuum include the supports 2335, 2335W-X or the like.

In some embodiments, the x-ray device 101 further comprises, for each of the means for individually supporting the means for generating x-rays within the vacuum, means for electrically connecting to the means for generating x-rays within the vacuum through the means for individually supporting the means for generating x-rays within the vacuum. Examples of the means for electrically connecting include feedthroughs 2435, or the like.

In some embodiments, the x-ray device 101 further comprises a single means for electrically connecting through the means for containing the vacuum to the separate means for generating x-rays within the vacuum. Examples of the single means for electrically connecting through the means for containing the vacuum include the feedthrough 2415.

In some embodiments, the x-ray device 101 further comprises at least one means for flexibly electrically connecting a pair of adjacent separate means for generating x-rays within the vacuum. Examples of the means for flexibly electrically connecting include the flexible internal electrical connections 2405, or the like.

Some embodiments include an x-ray device 101, comprising: a vacuum enclosure 102; a cathode module 1720, 17200-T disposed within the vacuum enclosure 102, comprising: a support structure; a compression plate 2026, 2026S-T; and a cathode stack 1722 clamped between the support structure and the compression plate 2026, 2026S-T, wherein the cathode stack 1722 includes a plurality of plates 1724 secured in a specified alignment.

In some embodiments, the cathode module 1720, 17200-T comprises a plurality of cathodes, each cathode 120 including at least one emitter 1927.

In some embodiments, the x-ray device 101 further comprises: a plurality of openings formed through the cathode stack 1722; and a plurality of fasteners 1926, each fastener 1926 secured to the support structure of the cathode module 1720, 17200-T through a respective opening of the plurality of openings.

In some embodiments, only a single opening of the plurality of openings formed through the cathode stack 1722 and a corresponding single fastener 1926 of the plurality of fasteners 1926 is disposed between adjacent cathodes of the cathode module 1720, 17200-T.

In some embodiments, the compression plate 2026, 2026S-T is one of a plurality of compression plates 2026, 2026S-T; the cathode stack 1722 is clamped between the support structure and the compression plates 2026, 2026S-T; and each fastener 1926 of the plurality of fasteners 1926 is configured to secure the cathode stack 1722 in the specified alignment between the support structure and a respective one of the compression plates 2026, 2026S-T.

In some embodiments, the cathode module 1720, 17200-T is one of a plurality of cathode modules 1720, 17200-T disposed in the vacuum enclosure 102; and one or more internal electrical connections configured to couple each cathode stack 1722 of the plurality of cathode modules 1720, 17200-T to a common electrical feedthrough 1815.

In some embodiments, the cathode stack 1722 comprises a ground plate, and wherein the ground plate is electrically coupled to a common ground connection by an internal electrical connection of the cathode module 1720, 17200-T.

In some embodiments, the x-ray device 101 further comprises one or more internal electrical connections configured to couple the ground plate of the cathode stack 1722 to a ground plate of a cathode stack 1722 of a cathode module 1720, 17200-T adjacent to the cathode module 1720, 17200-T within the enclosure 102.

In some embodiments, the support structure comprises a focus electrode.

In some embodiments, the cathodes 120 of the cathode module 1720, 17200-T comprise nanotube emitters.

Some embodiments include a method, comprising: stacking a plurality of plates on a support structure, the plurality of plates forming a plurality of cathodes for a plurality of x-ray sources; stacking at least one compression plate 2026, 2026S-T on the stacked plates on the support structure; and fastening the compression plate 2026, 2026S-T to the support structure to form a cathode module 1720, 17200-T.

In some embodiments, the method further comprises installing the cathode module 1720, 17200-T into an interior volume of a vacuum enclosure 102 after fastening the compression plate 2026, 2026S-T to the support structure to form the cathode module 1720, 17200-T.

In some embodiments, the support structure comprises a focus electrode, and wherein stacking the plates on the support structure further comprises securing the plates in alignment with the focus electrode.

In some embodiments, stacking the at least one compression plate 2026, 2026S-T on the stacked plates on the support structure comprises stacking a plurality of compression plates 2026, 2026S-T on the stacked plates on the support structure.

In some embodiments, the method further comprises: fastening each of the compression plates 2026, 2026S-T to the support structure with a single fastener.

Some embodiments include an x-ray device 101, comprising: means for containing a vacuum; a plurality of means for emitting electrons within the vacuum; means for support; and means for clamping the plurality of means for emitting electrons within the vacuum to the means for support. Examples of the means for containing a vacuum include the enclosure 102, the body 104, the covers 154, 154A-H, 1154, or the like. Examples of the means for emitting electrons within the vacuum include the cathodes 120, or the like. Examples of the means for support include the support structures 1920, or the like. Examples of the means for clamping include the compression plates 2026, or the like.

In some embodiments, the x-ray device 101 further comprises a plurality of means for fastening the means for clamping to the means for support. Examples of the means for fastening include the fasteners 1726, or the like.

In some embodiments, wherein a single means for fastening is disposed between each pair of the means for emitting electrons within the vacuum.

In some embodiments, the x-ray device 101 further comprises means for attaching the means for support to the means for containing the vacuum. Examples of the means for attaching the means for support include the fasteners 1726 or the like.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claim 1, 3, or 4, with these separate dependencies yielding three distinct embodiments; claim 6 can depend from any one of claim 1, 3, 4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f). Embodiments of the invention in which an exclusive property or privilege is claimed are defined as follows.

1. A x-ray device comprising:
an access port configured to receive a cathode within an interior volume of an enclosure of the x-ray device;
a first vacuum seal configured to seal a cover over the access port; and
a second seal configured to seal the cover over the access port, the second seal maintained between the first vacuum seal and the interior volume of the enclosure during removal of the first vacuum seal.

2. The x-ray device of claim 1, wherein:
the first vacuum seal is formed on a first path around the access port, and
the second seal comprises a physical overlap between the cover and the enclosure on a second path around the access port, the second path disposed between the first path and a perimeter of the access port.

3. The x-ray device of claim 1, wherein the access port is one of a plurality of access ports, each configured to receive a cathode within the interior volume of the enclosure of the x-ray device.

4. The x-ray device of claim 1 wherein the secondary seal comprises a protrusion configured to mate with a channel formed within one or more of the outer surface of the enclosure and the inner surface of the cover.

5. The x-ray device of claim 1, further comprising a releasable mechanism configured to seal a temporary cover over the access port, wherein the first vacuum seal is configured to replace the releasable vacuum seal with a permanent vacuum seal.

6. The x-ray device of claim 1, wherein:
the cathode is one of a plurality of cathodes of the x-ray device;
the access port is configured to receive a preassembled cathode module comprising a plurality of cathodes, the preassembled cathodes comprising a cathode stack comprising a plurality of plates secured in a specified alignment.

7. The x-ray device of claim 6, wherein each of the cathodes includes a plurality of emitters.

8. The x-ray device of claim 6, further comprising:
a plurality of openings formed through plurality of plates of the cathode stack;
a plurality of fasteners, each fastener secured to a support structure of the cathode module through a respective opening of the plurality of openings formed through the cathode stack; and
a compression plate, wherein a single opening of the plurality of openings formed through the cathode stack is disposed between adjacent preassembled cathodes of the cathode module, and wherein the fasteners are configured to secure the cathode stack between the compression plate and the support structure

9. The x-ray device of claim 1, further comprising:
a plurality of cathode modules, each cathode module comprising one or more cathodes and a compression plate configured to secure a cathode stack of the one or more cathodes to a focus electrode; and
at least one internal electrical connection coupled between the plurality of cathode modules.

10. The x-ray device of claim 1, further comprising:
an anode assembly comprising a plurality of anode modules, each anode module comprising one or more anodes; and
a plurality of supports, each support configured to secure a respective one of the plurality of anode modules of the anode assembly within an interior volume of the enclosure such that each anode module of the anode assembly is secured by a single support of the plurality of supports

11. A method, comprising:
sealing an access port of an enclosure with a first vacuum seal and a secondary seal, the enclosure having an interior volume comprising an x-ray source;
removing the first vacuum seal from the access port of the enclosure, comprising protecting the interior volume of the enclosure from contamination during removal of the first vacuum seal with the secondary seal; and
resealing the access port of the enclosure with a first vacuum seal after the removal of the first vacuum seal.

12. The method of claim 11, wherein sealing the access port comprises:
forming the secondary seal between the first vacuum seal and the interior volume of the enclosure; and
sealing a first cover over the access port with the first vacuum seal.

13. The method of claim 12, wherein resealing the access port further comprises reforming the secondary seal.

14. The method of claim 11, wherein the first vacuum seal comprises a weld joining the cover to the enclosure, and wherein removing the first vacuum seal comprises milling the weld.

15. The method of claim 12, wherein resealing the access port further comprises reforming the secondary seal.

16. The method of claim 11, wherein the first vacuum seal comprises a weld joining the cover to the enclosure, and wherein removing the first vacuum seal comprises milling the weld.

17. The method of claim 11, further comprising, before sealing the access port of the enclosure with the first vacuum seal and the secondary seal:
forming a releasable vacuum seal configured to seal a temporary cover over the access port;
testing the x-ray source;
removing the releasable vacuum seal;
sealing the access port with the first vacuum seal after removing the releasable vacuum seal.

18. The method of claim 16, wherein assembling the cathode module comprises:
forming a plurality of openings through the cathode stack such that a single opening through the cathode stack is formed between each pair of adjacent cathodes of the cathode module; and
clamping one or more compression plates over the cathode stack by a plurality of fasteners, each fastener installed through a respective opening of the plurality of openings.

19. The method of claim 11, further comprising:
assembling a cathode module comprising a plurality of cathodes, the cathodes comprising a cathode stack comprising a plurality of plates secured in a specified alignment; and
installing the assembled cathode module into the interior volume of the enclosure through the access port.

20. The method of claim 11, wherein assembling the cathode module comprises:
forming an anode assembly comprising a plurality of segments, each anode module comprising one or more anodes; and
mounting each anode module of the anode assembly within the enclosure by a single support of a plurality of structurally independent supports.

21. An x-ray device, comprising:
means for generating x-rays;
means for maintaining a vacuum around the means for generating x-rays, including:
means for accessing an interior volume of the means for maintaining the vacuum around the means for generating x-rays;
means for vacuum sealing the means for accessing the interior volume; and
means for protecting the interior volume from contamination during removal of the means for vacuum sealing the means for accessing the interior volume.

22. The x-ray device of claim 21, further comprising:
means for temporarily vacuum sealing the means for accessing the interior volume before attaching the means for vacuum sealing the means for accessing the interior volume.

23-56. (canceled)
